(19) United States
(12) Patent Application Publication
(10) Pub. No.: US 2022/0335098 A1
(43) Pub. Date: Oct. 20, 2022

(54) Method and Apparatus for Coupling the Internet, Environment and Intrinsic Memory to Users

(71) Applicant: TrackThings LLC, Murray Hill, NJ (US)

(72) Inventor: Thaddeus Gabara, Murray Hill, NJ (US)

(21) Appl. No.: 17/743,983

(22) Filed: May 13, 2022

Related U.S. Application Data
(63) Continuation of application No. 16/248,967, filed on Jan. 16, 2019.
Application No. 16/248,967 is a continuation of application No. 14/642,853, filed on Mar. 10, 2015, now abandoned.

(51) Int. Cl. G06F 16/9535; G06F 3/16

(52) U.S. Cl. CPC G06F 16/9535; G06F 3/167; G10L 13/00

(57) ABSTRACT

A Personal Memory Drive provides a system using memory and its database and kept in their personal possession. The database is segregated by firewalls to partition information into a public, a semi-private, a private section using firewalls. A PC accessed by the drive partitions the computer into segments thereby shadowing the drive segments. The drive allows private, local, and global databases to be searched and the results of the search snippets can be provided to the user. This search activity can be occurring during active conversations with others. The search analysis can also use sentence diagramming to partition the dialogue. The returned snippets can be filtered and processed by brain sensors coupled to the user. The device can aid the user where these search snippets can be used to enhance the conversation where some individuals of the party would not be aware of the aided help given to the user.

### CROSS REFERENCE TO RELATED APPLICATIONS

The present application is a continuation of the U.S. patent application entitled “Method and Apparatus for Coupling the Internet, Environment and Intrinsic Memory to Users” filed on Jan. 16, 2019 with Ser. No. 16/248,967 which is a continuation of the U.S. patent application entitled “Method and Apparatus for Coupling the Internet. Environment and Intrinsic Memory to Users” filed on Mar. 10, 2015 with Ser. No. 14/642,853 which are all invented by the same inventor as the present application and are all incorporated herein by reference in their entireties.

### BACKGROUND OF THE INVENTION

Computers are used in everyday life to seek information by typing in search phrases, viewing the results on the screen of a computer, and iteratively continuing the search process until an answer that is satisfying occurs. The searching is performed on the Internet using search tools such as GOOGLE™, BING™, or YAHOO™.

### BRIEF SUMMARY OF THE INVENTION

Various embodiments and aspects of the disclosures will be described with reference to details discussed below, and the accompanying drawings will illustrate the various embodiments. Some diagrams are not drawn to scale. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of the embodiments of the present disclosures.

These searches look for extrinsic data that is found on the Internet. This is basically any new information that the user is seeking, or information that the user once possessed but has forgotten. The information that the user has viewed but before the user had forgotten can be stored locally. When the search result shows up, the user can use these results advantageously knowing that the user had queried this information at an earlier date.

This disclosure helps to overcome this shortcoming in current systems for searching in databases that are extrinsic as found on the Internet. At least one additional database that is personal and intrinsic is formed and associated with the user or owner of the personal and intrinsic database. This database can be stored in memory that is local and personal called a Personal Memory Drive. This personal memory and its database can be carried by the user (owner) and kept in their personal possession. The memory can be encrypted and locked with failsafe locking software (codes, AES-256 bit encryption, body biometrics [iris print, fingerprint, brain waves, voice control, body odor detection, sweat analysis, breathing on the memory, etc.], body movements, etc.) or a physical manipulation of the device (spin 5 times one way then twice another way, squeezing the device, knock the device on tabletop 5 times, etc.) or a combination of any of the previous procedures to unlock the memory for access by the owner. If the memory is lost or falls into the wrong hands, the unlocking procedures to access the memory would prevent the other user from gaining memory access.

Another embodiment includes a security measure to perform a self-destruct of at least the personal database within a physical device. The personal database can contain, among other things: passwords; credit card information; medical data; favorite personal websites; personal private behavior trends; etc. If the memory is stored in Personal Memory Drive, the device can detect one of several cases when a separation between the Personal Memory Drive and the owner occurs. The device and owner leave together from a location (proper ownership), the device leaves while owner remains (potentially stolen device), the owner leaves while the device stays (owner forgot), and the owner leaves while the device stays wherein the device moves at a later time (device found by someone). If the Personal Memory Drive is stolen, a GPS detects the displacement, and downloads the sensitive content to the Internet over a communication protocol using a Secure Protocol. The device then writes over the entire memory database within the device to insure that recovery of the data from the memory database is not possible. The communication protocol could be any IEEE wireless access standard available in the vicinity. If the device is left behind, a message can be sent to the owner to tell them that the device was left at the given location. If the device is being accessed or moved, the removal protocol to delete the memory can begin. The user (owner) carries an RFID strip in their wallet where the Personal Memory Drive periodically interfaces with the RFD strip letting the Personal Memory Drive know that the owner and Personal Memory Drive share the same physical space.

A further embodiment allows the user to leave a second Personal Memory Drive in a secure place near or within their home. The first and second Personal Memory Drives communicates with each other when the distance between them is less than the distance of an IEEE wireless communication protocol. For example, Wi-Fi would have a range of 100 meters, while a WiGig channel would have a range within a room. The range of WiGig can be extended by forming a network within the home. When the second Personal Memory Drive is in the vicinity of the first Personal Memory Drive at the home, the user has a great likelihood that these two devices will be within range of each. At these times, the content between the two can be compared and updated as required. The second Personal Memory Drive provides the backup in case the first Personal Memory Drive is lost, or stolen, and cannot be backed up wirelessly.

Another embodiment offers a second option for storing the memory within a Personal Memory Drive. Here the memory can also be globally available and would be protected by keeping the memory encrypted with failsafe locking system such as AES-256 bit encryption which insures that the memory will not be compromised. These databases are stored on a server coupled to the Internet and can be accessed via an encryption key, code words, or passwords or a combination of all of the failsafe locking software techniques mentioned earlier. This database being both intrinsic as well as extrinsic offers additional search capabilities that were not available when the database was purely extrinsic. However, hackers can at times penetrate these databases without being given the permission. A database that is located in the Internet is more exposed to attack from other users, rather than, a database that is physically located with the owner. The owner can manipulate a switch on the device to absolutely block any access to the databases, including the owner himself. The switch physically disconnects a conduction path between the memory and any access port of the device. Virtually, it would be impossible to access the memory when the switch is in this state. However, keeping the database on the server allows access when the user forgets to bring or carry their Personal Memory Drive.

Hacking is an activity that users without permission seek to obtain information from restricted databases or memories. These databases are encrypted and protected by passwords in an effort to insure that the database is never compromised. However, hackers are persistent, clever, and diligent in their efforts and sometimes manage to break into databases that are restricted to them.

One of the embodiments of this disclosure allows the locally available memory or Personal Memory Drive to have an appearance of something similar to a memory stick. It would be small, portable, easy to carry in a pocket or purse, and readily available when needed. The modified memory stick will also have at least one firewall partition or a physical switch controlled by the owner. The firewalls can segregate information into a plurality of sections, while the switch can be used to isolate memory sections from one another. These various sections can be given privileges that allow others to view all, some, or none of the contents of one or more sections. For example, one section allows other users to search this particular database, another section allows only specified users to search the database, and there are sections which remain absolutely private where no one can enter to see what is contained inside the database other than the user (owner). The latter database contains the private matters of the user that the user does not want to share with anyone, for example: passwords; credit card information; medical data; favorite personal websites; personal private behavior trends; etc.

The physical switch and/or firewall being local within the Personal Memory Drive offers some benefits over the database within the server located on the Internet in one embodiment of the disclosure. The user has more control of the database within the memory stick than that of the database on the server since the user has a greater control of the Personal Memory Drive when the owner is in possession of the device.

Another embodiment regarding the locality of the Personal Memory Drive is that the device offers a greater control by the owner to prevent hackers from accessing their database. For instance, removing the Personal Memory Drive from the computer or disabling the wireless interface to the Personal Memory Drive insures that the Personal Memory Drive cannot be accessed. Another barrier to entry is inserting a physical switch in the Personal Memory Drive that placed in one position disconnect some or all sections of the intrinsic memory from all of the worldwide interface while another position of the switch allows some of the intrinsic memory to be shared. However, the second case would include addition failsafe mechanisms such as encryption coding, passwords etc. that would be required before the contents of the intrinsic memory can be revealed. In addition, a record of all transfers are stored providing the date, time, contents exposed, etc. of all data accesses that occurred to and from the intrinsic memory within the memory stick. This record of transfers in and out of the device can be checked to see if the system has been breached.

Another embodiment insures security by partitioning the user's computer into segments thereby shadowing the Personal Memory Drive segments. The computer would have an extrinsic interface segment that interacts with the internet and at least one additional segment that is isolated from the extrinsic interface called the intrinsic interface. A firewall exists between the intrinsic interface and the extrinsic interface which isolates the intrinsic section from the extrinsic section. Now, there are two parallel failsafe mechanisms in place. The computer and Personal Memory Drive are both partitioned. The partitioning of the computer can be controlled by the instructions contained within the Personal Memory Drive. In this case, the hacker needs to penetrate at least two layers to get to the intrinsic database. The first layer being the computer interface, the second layer being the memory interface. Both the memory and the computer can each contain more than one firewall interface.

Another embodiment of the disclosure describes how intrinsic memory or Personal Memory Drive can be divided into a public, a semi-private, a private section using firewalls. The public memory can be shared with others, the semi-private memory with selected individuals, and the private memory with no one else. The later contains the private information of the user or owner. The content within these different memory divisions can be used to make decisions with oneself, decisions with another, and decisions among several individuals, decisions with another while excluding a third individual (even though the third individual is present), or decisions with another while excluding the other from knowing that the user or owner has access to data that the other does not have. This later situation can occur if the Personal Memory Drive is inserted and hidden into the ear canal of the owner.

A further embodiment is where the intrinsic memory would be within the Personal Memory Drive as mentioned earlier, but the Personal Memory Drive will be enhanced with more than just a memory stick (a memory storage device) that all of us are familiar with. It would be a Personal Memory Drive comprises a server interface, display interface, a processing engine, a local search engine, a local server or database, various memories (Flash, RAM, ROM), transducers, transceivers, small display screen, and operating systems. The Personal Memory Drive can function as a miniature computer that can be placed in a pocket or even into the ear canal. The operating system manages the hardware and software resources of the system, provides services for computer programs, and insures that the system functions properly.

The Personal Memory Drive can be partitioned internally within the device as a Public Memory Drive and a Private Memory Drive in another embodiment of the disclosure. The Public Memory Drive interfaces with the Private Memory Drive, the Internet, another computer, or another Personal Memory Drive. The Private Memory Drive interacts with the Public Memory Drive though a firewall or protective layer. The Public Memory Drive comprises a server interface, a processing engine, a public search engine, a local server or database, various memories (Flash, RAM, ROM), transducers, transceivers, and operating systems. The firewall couples the Public Memory Drive to the Private Memory Drive which comprises a private processing engine, a private search engine, a private local server or database, various private memories (Flash, RAM, ROM), transducers, transceivers, and a personal operating system. The Private Memory Drive and its contents are private and can be shared with the Internet using the Public Memory Drive as an interface.

The Personal Memory Drive can be physically partitioned into two separate devices in another embodiment. The Public Memory Drive would be connected to the Private Memory Drive either wirelessly, or in some cases, wired. This allows the two individual pieces of Personal Memory Drive to be placed near different parts of the user's body. One case is to place the Public Memory Drive in a pocket or purse, while the Private Memory Drive can be placed near or in the vicinity of the ear. The Private Memory Drive can be embedded within eye-glasses, formed to fit within the external portion of the ear, or shaped to fit within the ear canal preventing it to be seem by others. The Public Memory Drive interfaces wirelessly with the internet, a local computer, another Personal Memory Drive which in turn interfaces to the internet. The Public Memory Drive also interfaces with the Private Memory Drive wirelessly. The Personal Memory Drive communicates with the owner via the response of transducers that create: sound; vibrations; temperature; movement (MEMS); light (LED); voltage (brain waves); etc. The sound can be transmitted through air to the ear sensory organ, through bone and flesh to the ear sensory organ, or a combination of both. Vibrations, temperature, or movement applied to the human body can be felt. Light can be seen. Voltage can be used to detect or excite brain wave stimulus.

Both devices: the Private Memory Drive and Public Memory Drive can have transducers to receive and produce sound in another embodiment of the disclosure. The user can wear the Private Memory Drive within the ear canal hidden from view and the Public Memory Drive can be placed in a pocket. As the user or others speak, both devices detect the voice and analyze the contents. The speech is converted to text. Private, local, and global databases can be searched and the results of the search snippets can be provided to the user. Snippets are small samples of content in a webpage that can be indicative of the content of that webpage. A text to speech block uses the readable text of the content and provides the information from snippets to the user to enhance their knowledge. This activity can be occurring during conversations with others or when the user is alone and in concentration.

The text of the speech can be segregated into nouns, verbs, adjective, adverbs and other parts of a sentence in another embodiment of the disclosure. In addition, the analysis can also use sentence diagramming (Reed-Kellogg system) to determine the structure of the sentence. The base terms of the diagram comprises the subject, predicate, verb, direct object, or predicate noun of the sentence which can be identified from the sentence diagramming. Some of these primary keywords can be selected from the base terms and used as search terms that can be applied to the various databases; private, local, or global. The secondary keyword is the adjectives and adverbs. The analysis can also use phase structure or dependency grammar to form trees and use these trees to extract search terms by using the constituency relation.

The selected parts of the sentence, or base keywords, are presented to the search engines of the Private Memory Drive, Public Memory Drive, and the one in the Internet (GOOGLE™, BING™, or YAHOO™) in another embodiment of the disclosure. The search engines used in the Private Memory Drive and Public Memory Drive can specially designed, derived from the search engines available in the Internet, or use the same code as the search engines in the Internet. On the Personal Memory Drive, a search can occur over one or all of the segments of the Personal Memory Drive.

The Private Memory Drive and Public Memory Drive can search their internal database while the Public Memory Drive, in addition, searches the Internet for some of the key words in another embodiment. The results, if any, from each of the segments is combined with the search results from the Internet. The returned snippets can be stored in a textual format (or converted into speech and stored in a speech format). The snippets from the Public Memory Drive which contains the results of the local database and the internet are transferred (wirelessly, for example) to the Private Memory Drive within the ear canal of the user. The snippets are converted from text to sound and applied to the transducers. The transducers within the Private Memory Drive apply the stimulus (sound, vibrations, etc.) to ear canal which can be sensed (heard, felt, etc.) by the user.

Not all snippets are necessarily heard by the user. A filtering process can be used where a portion of the snippets are heard in another embodiment. The filtering process can be determined by the Personal Memory Drive which can use moments of silence in the conversation to transfer the snippets to the user so the user does not lose content within the active conversation that is occurring. The filtering process can also be controlled by brain waves of the user which the Personal Memory Drive can sense. For example, the Private Memory Drive placed in the ear canal can use brain sensor transducers that can allow communication with the user. Some of the relatively inexpensive brain sensors use electroencephalography (EEG), electrocorticography (ECoG), and single-neuron recordings. These sensors can be placed near the surface of the Private Memory Drive and placed in contact with the ear canal. The user can then signal to the Private Memory Drive to voice more snippets into the ear canal when the user is on top of the active conversation and requires more information that the user feels can be used to add content to the ongoing active conversation.

Another embodiment of filtering can be overwriting snippets with newer snippets if the conversation is proceeding faster than the system can create the snippets. As the conversation is changing, some of the older snippet results pertain to conversations that have since expired. In order to stay on top of the conversation, these older snippets can be over written.

The intrinsic memory can be used to make decisions with oneself in combination with the database content of the Internet, database content of a local computer and with the various divided sections of the intrinsic memory when performing a search of a term, word, thing, or item of interest in another embodiment. The device behaves as a personal assistant. For instance, the user in isolation can perform a search of terms verbally worded in private: “patent” “last week” “discussion with John Titan” by wording out these terms so that the Personal Memory Drive will hear these sounds, convert them to text, and perform a search over the private and local database. These databases have stored the discussion with John Titan from a week ago and can locate the particular patent from the week before. The Private Memory Drive provides details of that particular patent or patents to the user by providing some details of the patent, such as, patent number, issue date, an abstract of the patent, an independent claim, etc.

In another embodiment of the disclosure, if the user performed the search of terms verbally worded in private: “patent” “last week” “discussion with John Titan” by wording out these terms so that the Personal Memory Drive will hear these sounds, convert them to text, and perform a search over the private and local database while the user is sitting near a computer, the Personal Memory Drive can communicate wirelessly with the computer and instruct the computer to display the patent or patents on the screen. Now the user can peruse the patents for the particular item the user desired. Thus, the results of the verbal search can be displayed on a computer that is in contact with the Personal Memory Drive.

The intrinsic memory can be used to make decisions while in discussions with others within a room in another embodiment. The Private Memory Drive and the Public Memory Drive can listen to an active conversation, perform a search within its various databases, listen to some of the snippets, and use these snippets to enhance the conversation. The Private Memory Drive and the Public Memory Drive can be hidden from view of the remaining participants in the discussion (an incognito state), thus the other participants will not know the user is being aided by the search engine operations that the Personal Memory Drive is performing. The user can superficially seem to be a smarter person by using the Personal Memory Drive.

When the discussions include three or more individuals, two of the party can be wearing their own Private Memory Drives and the Public Memory Drives in an incognito state and control and manipulate the discussion particularly if this is a business meeting in another embodiment. The Private Memory Drive and the Public Memory Drive of the two users can furthermore communicate with each other to cause a more favorable decision in the business discussion. The remaining individuals of the party would not be aware of the aided help those in the incognito state are being provided.

Another embodiment relates to a Personal Memory Drive for a conversation comprising: a personal memory drive coupled to an owner; wherein the personal memory drive is configured to transmit search terms extracted from the conversation to at least one database and is configured to receive search results from the at least one database; and a text to speech translator configured to convert the search results to a search result speech, wherein of the search result speech, at least one snippet is configured to be heard by the owner. The apparatus, wherein the snippet is configured to be generated during the conversation between the owner and others, wherein the snippet is configured to be heard by the owner during a period of silence in the conversation or during a period of concentration of the owner that is sensed by a brain wave transducer in the personal memory drive that is in contact with an ear canal of the owner, wherein the personal memory drive is inserted within an ear canal of the owner, wherein the personal memory drive can be hidden from view, wherein the at least one database is selected from the group consisting of a private database available only to the owner, a public database available to other users selected by the owner and an Internet database available to anyone, wherein the personal memory drive is configured to communicate with other personal memory drives owned by other users, other PCs, and the Internet. The apparatus further comprising: at least one local search engine configured to search at least one local memory, wherein the at least one local memory is configured to have at least one local database; and at least one local server serving the at least one local database, wherein a dialogue of the conversation is heard by the owner: a reply to the dialogue is thought out by the owner after integrating both the dialogue and the at least one snippet from the total search speech, wherein the reply is added to the conversation by the owner. The apparatus further comprising: at least one transceivers to interface wirelessly to other personal memory drives, other PCs, and the Internet; and one of more operating systems configured to manage the hardware and software resources of the system, provide services for computer programs, and insure that the system functions properly; at least one transducer configured to sense voltage, electromagnetic, electrochemical, electromechanical, electroacoustic, or electro-optical signals; at least one a server interface configured to interface to other servers; and at least one processing engine.

Another embodiment relates to a Personal Memory Drive comprising: a private memory drive coupled to an owner; and a public memory drive wirelessly coupled to the private memory drive, wherein the public memory drive is configured to transmit search terms to the Internet and is configured to receive global search results from the Internet, wherein the public memory drive is configured to transmit the search terms to its public database and is configured to receive public search results from its public database, wherein the private memory drive is configured to transmit the search terms to its private database and is configured to receive private search results from its private database, wherein the public and global search results received by the public memory drive are transmitted to the private memory drive, wherein all search results are combined into a total search result; and a text to speech translator configured to convert the total search result to a total search speech, wherein of the total search speech at least one snippet is configured to be heard by the owner. The apparatus wherein the snippet is configured to be generated during a conversation between the owner and others, wherein the snippet is configured to be heard by the owner during a period of silence in a conversation or during a period of concentration of the owner that is sensed by a brain wave transducer in the personal memory drive that is in contact with the ear canal of the owner, wherein the private memory drive is inserted within the ear canal of the owner, wherein the private memory drive can be hidden from view, wherein the conversation is occurring between the owner and at least one other person selected from the group consisting of a person sharing a room with the owner, a person sharing a telephone call with the owner and a person not aware the owner is being aided by the PMD, wherein the personal memory drive is configured to communicate with other personal memory drives, other PCs, and the Internet. The apparatus further comprising: at least one local search engine configured to search at least one local memory, wherein the at least one local memory is configured to have at least one local database; and at least one local server comprising the at least one local database. The apparatus further comprising: at least one transceivers to interface wirelessly to other personal memory drives, other PCs, and the Internet; and one of more operating systems configured to manage the hardware and software resources of the system, provide services for computer programs, and insure that the system functions properly; at least one transducer configured to sense voltage, electromagnetic, electrochemical, electromechanical, electroacoustic, or electro-optical signals; at least one a server interface configured to interface to other servers; and at least one processing engine, wherein a dialogue of the conversation is heard by the owner; a reply to the dialogue is thought out by the owner after integrating both the dialogue and the at least one snippet from the total search speech, wherein the reply is added to the conversation by the owner, wherein a dialogue of the conversation is heard by the owner; a reply to the dialogue is thought out by the owner after integrating both the dialogue and the at least one snippet from the total search speech, wherein the reply is added to the conversation by the owner.

Another embodiment relates to a Personal Memory Drive comprising: a private memory drive coupled to an owner, and a public memory drive coupled to the private memory drive, wherein the public memory drive is configured to transmit search terms to a first database and is configured to receive first search results from the first database, wherein the public memory drive is configured to transmit the search terms to its own database and is configured to receive second search results from its own database, wherein the first and second search results received by the public memory drive are transmitted to the private memory drive, wherein the first and second search results are combined into a total search result; and a text to speech translator configured to convert the total search result to a total search speech, wherein of the total search speech at least one snippet is configured to be heard by the owner. The apparatus wherein the snippet is configured to be generated during a conversation between the owner and others, wherein the snippet is configured to be heard by the owner during a period of silence in a conversation or during a period of concentration of the owner that is sensed by a brain wave transducer in the personal memory drive that is in contact with the ear canal of the owner, wherein the private memory drive is inserted within the ear canal of the owner, wherein the private memory drive can be hidden from view, wherein the at least one database is selected from the group consisting of a private database available only to the owner, a public database available to other users selected by the owner and a Internet database available to anyone, wherein the personal memory drive is configured to communicate with other personal memory drives, other PCs, and the Internet. The apparatus further comprising: at least one local search engine configured to search at least one local memory, wherein the at least one local memory is configured to have at least one local database; and at least one local server comprising the at least one local database. The apparatus further comprising: at least one transceivers to interface wirelessly to other personal memory drives, other PCs, and the Internet; and one of more operating systems configured to manage the hardware and software resources of the system, provide services for computer programs, and insure that the system functions properly; at least one transducer configured to sense voltage, electromagnetic, electrochemical, electromechanical, electroacoustic, or electro-optical signals; at least one a server interface configured to interface to other servers; and at least one processing engine, wherein a dialogue of the conversation is heard by the owner; a reply to the dialogue is thought out by the owner after integrating both the dialogue and the at least one snippet from the total search speech, wherein the reply is added to the conversation by the owner.

Another embodiment relates to a Personal Memory Drive configured to operate in a conversation comprising: a private memory drive with a first speech to text convertor, wherein the private memory drive is coupled to an owner; a public memory drive with a second speech to text convertor and coupled to both the private memory drive and the Internet, wherein the first speech to text convertor and second speech to text convertor are configured to translate the conversation into a first text and a second text, respectively; a first search engine coupled to the private memory drive and configured to search in a first database of at least one search term extracted from the first text; a second search engine coupled to the public memory drive and configured to search in at least one or more other databases of the at least one search term extracted from the second text, wherein a first search result from the at least one or more other databases is transferred to the private memory drive and a second search result from the first database are combined into a total search result; and a text to speech convertor in the private memory drive converter configured to convert at least one snippet of the total search result to speech, wherein the at least one snippet of speech is configured to be heard by the owner. The apparatus, wherein the at least one or more databases includes a database in the public memory drive and a database of the Internet, wherein at least one person in the conversation is not coupled to any databases, wherein the at least one snippet of speech is configured to be heard by the owner during a period of silence in a conversation or during a period of concentration of the owner that is sensed by a brain wave transducer in the personal memory drive that is in contact with the ear canal of the owner, wherein the personal memory drive is inserted within the ear canal of the owner, wherein the personal memory drive can be hidden from a view of others in the conversation. The apparatus wherein the at least one snippet of speech heard by the owner is integrated into a thought of the owner, the result of which is added into the conversation by the owner, wherein the at least one snippet of speech heard by the owner is added into the conversation by the owner, wherein an analysis based on a sentence diagram determines the structure of at least one sentence in the first text and the second text, wherein the at least one search term is extracted from base terms of the sentence diagram of the at least one sentence, wherein the base terms comprises the subject, predicate, verb, direct object, or predicate noun of the at least one sentence

Another embodiment relates to a Personal Memory Drive comprising: a multilayer board with at least one chip connected to the multilayer board; an accessible positive power lead and an accessible negative power lead coupled to the multilayer board; at least one transducer configured to sense voltage, electromagnetic, electrochemical, electromechanical, electroacoustic, or electro-optical signals; at least one antenna; at least one magnet; a private memory drive, wherein the private memory drive stores a private database accessible only by an owner of the personal memory drive; a public memory drive stores public database that can be shared with others and is coupled to both the private memory drive and the Internet; a private search engine configured to search the private database; and a public search engine configured to search the public database and the Internet, wherein at least one snippet of all search results is provided to the owner. The apparatus further comprising: an auxiliary battery pack comprising: at least one opposite polarity magnet coupling to the at least one magnet; at least one battery configured to provide power to the at least one chip; and a positive power lead and a negative power lead configured to couple to the accessible positive power lead and the accessible negative power lead, respectfully, further comprising: at least one male plug, wherein at least one of the male plugs is an USB standard Male-A plug, further comprising: at least one female plug, wherein at least one of the female plugs is an USB Female-A plug. The apparatus further comprising: at least one earphone coupled to the at least one female plug, wherein audio is stored in at least one of the databases and that is configured to play the audio on the at least one earphone.

Another embodiment relates to a Personal Memory Drive comprising: an operating system; at least one database configured to store audio; a buffer interface coupled to at least one amplifier stage; a USB standard Male-A plug coupled to the at least one amplifier stage; a USB standard Female-A plug configured to connect to the USB standard Male-A plug; a digital to analog converter coupled to the USB standard Female-A plug; and at least one headphone coupled to the digital to analog converter, wherein audio stored in at least one of the databases is configured to play the audio on the at least one earphone.

Another embodiment relates to an Integrated Personal Memory Drive (PMD) comprising: at least one firewall segregating the integrated personal memory drive into two or more devices; a first section comprising: a server interface configured to couple to a personal computer (PC), another PMD, or the Internet; an operating system configured to manage the hardware and resources of the first section; at least one database to store and to access data shared with the Internet or a selected group; a local server configured to interface to the at least one database; a public search engine configured to search the at least one database or the Internet; and a processing engine configured to run the operating system; a second section comprising: a personal operating system configured to manage the private hardware and private resources of the second section; at least one private database to store and to access the private data; a private server configured to interface to the at least one private database; a private search engine configured to search the at least one private database; and a private processing engine configured to run the personal operating system, wherein only an owner of the PMD can access the at least one private database.

Another embodiment relates to an segregated Personal Memory Drive (PMD) configured to operate in a conversation comprising: a first device comprising: a server interface configured to couple to a personal computer (PC), another PMD, or the Internet; an operating system configured to manage the hardware and resources of the first device; at least one database to store and to access data shared with the Internet or a selected group; a first speech to text convertor coupled to the Internet, wherein the first speech to text convertor is configured to translate the conversation into a first text; a first search engine coupled to the at least one database and configured to search in at least one or more other databases for at least one search term extracted from the first text; a second device, separated from the first device, coupled to an owner comprising: a personal operating system configured to manage the private hardware and private resources of the second device; at least one private database to store and to access private data, wherein only the owner of the PMD can access the at least one private database; a second speech to text convertor configured to translate the conversation into a second text; a second search engine coupled to the at least one private database and configured to search in the at least one private database for the at least one search term extracted from the second text, wherein the search results of the first search engine and the search results of the second search engine are combined into a total search result; a text to speech convertor configured to convert at least one snippet of text extracted from the total search result to at least one snippet of speech, wherein the at least one snippet of speech is configured to be heard by the owner, wherein the private database can be encrypted with at least one of a locked with failsafe locking software or a physical manipulation of the second device, wherein the first device and the second device are configured to couple wirelessly through at least one firewall, wherein both devices are located near the owner, wherein the at least one search term extracted from the first text and the at least one search term extracted from the second text comprise at least one common term, word, thing, or item of interest.

Another embodiment relates to a method of partitioning a personal computer (PC) comprising the steps of: waiting until the PC is finished being used; initializing the PC to an initial state; completing a handshake between the PC and a Personal Memory Drive (PMD); downloading software from the PMD to emulate an operating system (OS); partitioning the PC into a plurality of sections opening a corresponding number of windows; installing a firewall between each two interacting sections; installing a firewall between a section interfacing to the Internet and the Internet; downloading files and software tools from the Internet to at least one of the plurality of sections; downloading public files and public software tools from a PMD to at least another one of the plurality of sections; downloading private files and private software tools from a PMD to at least yet another one of the plurality of sections; and hovering a mouse over one of the windows providing an indication of one of the plurality of sections is active, wherein the indication is selected from the group consisting of a change in the color of the window, a creation of an audible sound, and a change in the color of text within the window.

Another embodiment relates to a method of an owner of a Personal Memory Drive (PMD) and the PMD both responding to a conversation comprising the steps of: listening to a dialogue of a conversation performed by the owner; thinking about a reply to the dialogue performed by the owner; configuring a speech to text device of the PMD to translate the dialogue into text; selecting search terms from die text of the dialogue performed by the PMD; searching in at least one database for the search terms performed by the PMD; queuing a result of the searching into a queue database performed by the PMD; selecting at least one snippet from the queue database performed by the PMD; configuring a text to speech device of the PMD to translate the at least one snippet into a search result dialogue; providing the search result dialogue to the owner; integrating at least one thought between that of thinking about the reply to the dialogue and the search result dialogue provided to the owner by the PMD; and replying to the dialogue of the conversation using a result of integrating the at least one thought, wherein the conversation is occurring between the owner and at least one other person selected from the group consisting of a person sharing a room with the owner, a person sharing a telephone call with the owner and a person not aware the owner is being aided by the PMD, wherein the at least one database is selected from the group consisting of a private database available only to the owner, a public database available to other users selected by the owner and a database of the Internet available to anyone, wherein the at least one snippet is configured to be heard by the owner during a period of silence in a conversation or during a period of concentration of the owner that is sensed by a brain wave transducer that is in contact with an ear canal of the owner in the PMD, wherein the at least one snippet is configured to be generated during a conversation between the owner and others, wherein the PMD is inserted within the ear canal of the owner, wherein the PMD can be hidden from view, wherein the PMD is configured to communicate with other PMDS, other PCs, and the Internet. The method further comprising the steps of: configuring at least one local search engine to search at least one local memory, wherein the at least one local memory is configured to have at least one local database, wherein the at least one local database comprises at least one local server, further comprising the steps of: wirelessly interfacing to other PMDs, other PCs, and the Internet with at least one transceiver; and configuring one of more operating systems to manage the hardware and software resources of the system, provide services for computer programs, and insure that the system functions properly; configuring at least one transducer to sense voltage, electromagnetic, electrochemical, electromechanical, electroacoustic, or electro-optical signals; and configuring at least one a server interface to interface to other servers.

### BRIEF DESCRIPTION OF THE DRAWINGS

Please note that the drawings shown in this specification may not necessarily be drawn to scale and the relative dimensions of various elements in the diagrams are depicted schematically. The disclosures presented here may be embodied in many different forms and should not be construed as limited to the embodiments set forth herein. Rather, these embodiments are provided so that this disclosure will be through and complete, and will fully convey the scope of the disclosure to those skilled in the art. In other instances, well-known structures and functions have not been shown or described in detail to avoid unnecessarily obscuring the description of the embodiment of the disclosure. Cross-sectional views may be illustrated where both solid and dotted lines in conjunction with the written text convey the concept allowing the diagrams to be easily viewed and understood.

FIG. 1A depicts a laptop communicating to a server through the Internet.

FIG. 1B shows the block diagram representation of FIG. 1A.

FIG. 2A illustrates a portable device communicating to a server through the Internet.

FIG. 2B presents a block diagram of the portable device that can communicate wirelessly.

FIG. 3 depicts the Internet communicating with wearable devices, portable devices, laptops, computers and a USB drive coupled to the laptop or computer.

FIG. 4A shows a part of the block diagram of a USB memory stick.

FIG. 4B illustrates another part of the block diagram of a USB memory stick.

FIG. 5A depicts a partial block diagram of a Personal Memory Drive of one embodiment in accordance with the present disclosure.

FIG. 5B illustrates an additional block diagram of a Personal Memory Drive of one embodiment in accordance with the present disclosure.

FIG. 6 depicts a block diagram of a Personal Memory Drive in communication with the Internet and a local device of one embodiment in accordance with the present disclosure.

FIG. 7A depicts a cross-sectional view of a Personal Memory Drive of one embodiment in accordance with the present disclosure.

FIG. 7B shows a cross-sectional view of a Personal Memory Drive of another embodiment in accordance with the present disclosure.

FIG. 8A illustrates a cross-sectional view of a Personal Memory Drive of another embodiment in accordance with the present disclosure.

FIG. 8B shows a cross-sectional view of a Personal Memory Drive of another embodiment in accordance with the present disclosure.

FIG. 9A depicts a Personal Memory Drive coupled to a battery pack of one embodiment in accordance with the present disclosure.

FIG. 9B illustrates a Personal Memory Drive coupled to a battery pack of another embodiment in accordance with the present disclosure.

FIG. 10A illustrates a male-female connector coupling the Personal Memory Drive to a headset of one embodiment in accordance with the present disclosure.

FIG. 10B depicts a more detailed electronic schematic of the male-female connector coupling the Personal Memory Drive to a headset of one embodiment in accordance with the present disclosure.

FIG. 12 shows the Internet communicating with wearable devices, portable devices, laptops, computers and a USB drive coupled to the laptop or computer.

FIG. 13 presents the Internet communicating with wearable devices, portable devices, Personal Memory Drive, laptops, computers and a Personal Memory Drive coupled to the laptop or computer of one embodiment in accordance with the present disclosure.

FIG. 14 depicts a block diagram of the Internet interfacing to a block diagram of the Personal Memory Drive of one embodiment in accordance with the present disclosure.

FIG. 15 shows a block diagram of the Internet interfacing to a block diagram of the Personal Memory Drive partitioned into a Public Memory Drive and a Private Memory Drive of one embodiment in accordance with the present disclosure.

FIG. 16A presents a block diagram of the Internet interfacing to a block diagram of the Personal Memory Drive partitioned into separate devices: a Public Memory Drive and a Private Memory Drive coupled by wireless signals of one embodiment in accordance with the present disclosure.

FIG. 16B depicts a high level diagram of the Internet interfacing to a PC that interfaces to the Personal Memory Drive of one embodiment in accordance with the present disclosure.

FIG. 17A shows a Personal Memory Drive coupled to a Desktop of one embodiment in accordance with the present disclosure.

FIG. 17B illustrates a Personal Memory Drive coupled to a Dumb terminal of one embodiment in accordance with the present disclosure.

FIG. 17C depicts a Personal Memory Drive coupled to a Desktop partitioned to have a dumb terminal of one embodiment in accordance with the present disclosure.

FIG. 17D illustrates a Personal Memory Drive coupled to a Desktop initialized to have a dumb terminal after last use of one embodiment in accordance with the present disclosure.

FIG. 18 depicts the different ways a Personal Memory Drive can couple to the Internet via other devices of one embodiment in accordance with the present disclosure.

FIG. 19 depicts a flowchart initializing a PC and downloading an OS using a Personal Memory Drive to access the public database of one embodiment in accordance with the present disclosure.

FIG. 20 shows a flowchart initializing a PC and downloading an OS using a Personal Memory Drive to access the different databases of another embodiment in accordance with the present disclosure.

FIG. 21 illustrates a flowchart identifying if a Personal Memory Drive is in the vicinity of a PC of another embodiment in accordance with the present disclosure.

FIG. 22A shows a user with the entire Personal Memory Drive in the ear canal which is communicating with the Internet of another embodiment in accordance with the present disclosure.

FIG. 22B depicts a Personal Memory Drive within the ear canal of one embodiment in accordance with the present disclosure.

FIG. 23A illustrates a Personal Memory Drive partitioned into a Public and Private Memory Drive with the Private Memory Drive within the ear canal of another embodiment in accordance with the present disclosure.

FIG. 23B illustrates a Private Memory Drive within the ear canal of one embodiment in accordance with the present disclosure.

FIG. 24A depicts a Personal Memory Drive partitioned into a Public and Private Memory Drive with the Private Memory Drive within eyeglasses of one embodiment in accordance with the present disclosure.

FIG. 24B shows a Private Memory Drive within the eyeglasses of one embodiment in accordance with the present disclosure.

FIG. 25 presents a block diagram representation of the user, Private Memory Drive and Public Memory Drive in communication with the Internet, each other, and audio sources of one embodiment in accordance with the present disclosure.

FIG. 26 depicts the Private Memory Drive and Public Memory Drive communicating with the Internet, interpreting dialog, and responding to the dialog of one embodiment in accordance with the present disclosure.

FIG. 27 shows the Private Memory Drive and Public Memory Drive communicating with the Internet, interpreting dialog of another person, and responding to the dialog of the other person of one embodiment in accordance with the present disclosure.

FIG. 28A presents a flowchart of the Private Memory Drive and Public Memory Drive communicating with the Internet, interpreting dialog, and responding to the dialog of one embodiment in accordance with the present disclosure.

FIG. 28B depicts a flowchart of the Private Memory Drive and Public Memory Drive communicating with the Internet, interpreting dialog, and responding to the dialog and selecting the best response of one embodiment in accordance with the present disclosure.

FIG. 29 presents the communication of two users Private Memory Drive and Public Memory Drive communicating with the Internet, interpreting dialog of a third person, and responding to the dialog of the third person who is unaware that the two users are coupled together of one embodiment in accordance with the present disclosure.

FIG. 30A-C depicts a flowchart the communication of two users Private Memory Drive and Public Memory Drive communicating with the Internet, interpreting dialog of a conversation, and responding to the dialog of the conversation where a person may be unaware that the two users are coupled together of one embodiment in accordance with the present disclosure.

### DETAILED DESCRIPTION OF THE INVENTION

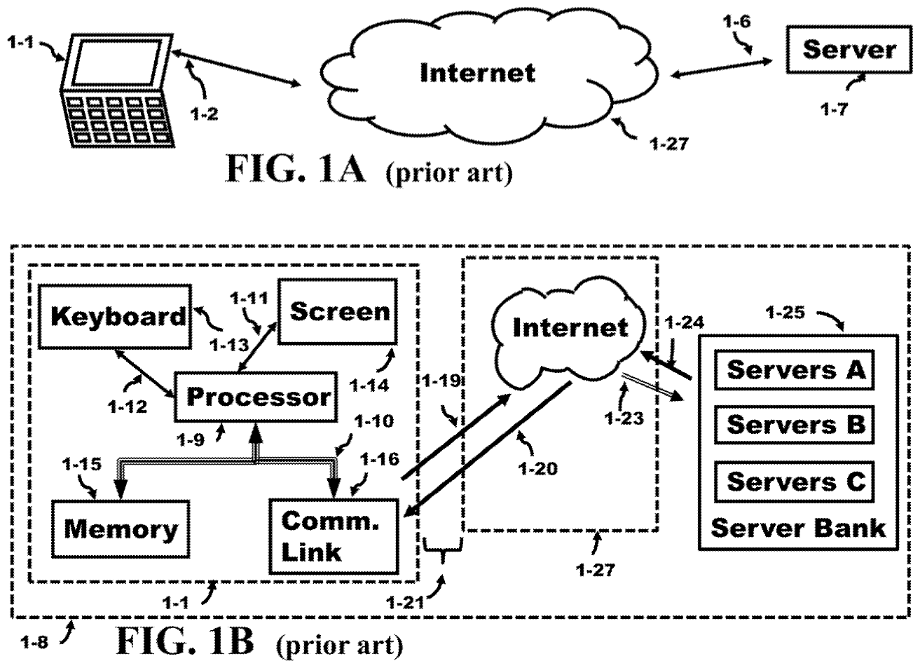

FIG. 1A illustrates a notebook computer with its pathways going to through the Internet to a server. The notebook computer 1-1 can wirelessly interconnect to an Internet 1-27 which along the path 1-2 connects up to the Internet. The Internet 1-27 has a connection 1-6 to at least one server 1-7. This path is bidirectional and allows the user of the notebook 1-1 to access the server's database for data, or to manipulate the server.

FIG. 1B presents a more descriptive illustration of the individual components that are in FIG. 1A. The entire system is in 1-8 which contains the notebook computer 1-1, the interface 1-21 between the computer and the Internet 1-27, the interface 1-23 and 1-24 between the Internet 1-18 and the set of servers A-Z 1-25. The notebook 1-1 contains a keyboard 1-13 coupled to the processor by a network 1-12, a screen 1-14 coupled to the processor by interface 1-11. A communication bus 1-10 coupling the processor 1-9 to the memory 1-15 and a communication link 1-16. The communication link 1-16 couples through the bi-directional interface 1-19 and 1-20 to the Internet 1-27. The Internet can then couple to the servers 1-25 via the interconnect 1-24 and 1-23.

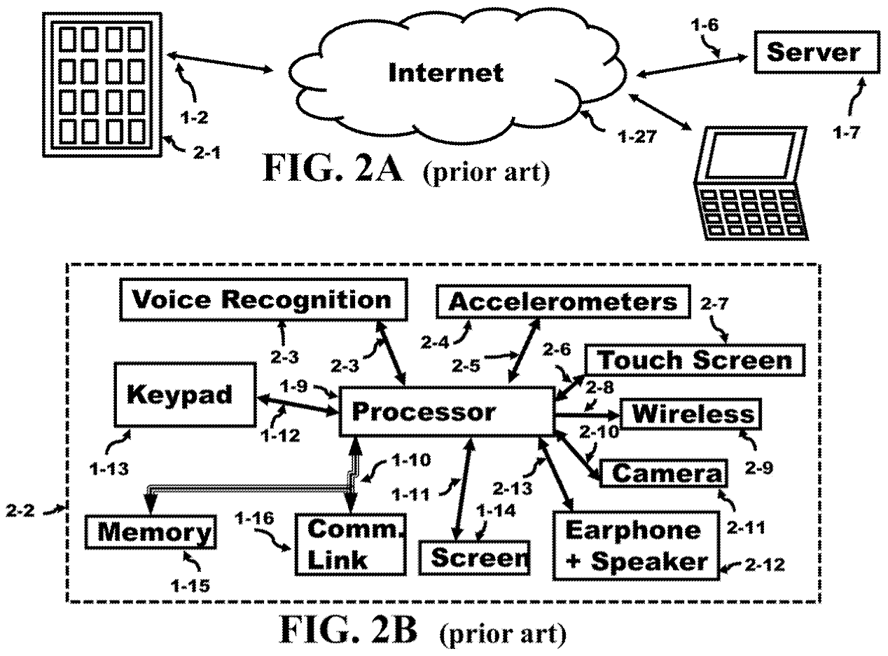

FIG. 2A presents a portable hand-held device or a smart phone 2-1 coupled to the Internet by 1-2. The Internet can couple to multitude of devices such as: servers, computers, and other wireless devices. The portable device 2-1 is coupled to the Internet 1-27 by the interface 1-2 and the Internet 1-27 is coupled to the servers 1-7 by the interface 1-6. The interconnects 1-2 and 1-6 are bi-directional allowing the portable unit or smart phone 2-1 to access the servers 1-7 for data or for the server to present data to the smart phone 2-1. The smart phone has a display screen that currently is presenting icons of various applications (the array of rectangles).

FIG. 2B presents a block diagram 2-2 of the smart phone 2-1. The smart phone contains a processor 1-9 coupled by a bus 1-10 to a memory 1-15 and a communication link 1-16. The processor also interfaces to a keypad 1-13 through the interface 1-12 and to a screen 1-14 by the interface 1-11. Also possible, the screen can present a keyboard to the user. In addition, the processor can have other features which allow the user easier access to the device, as well as, providing additional input to the smart phone. For example, the smart phone can contain a voice recognition unit 2-3 that communicates to the processor by interface 2-3. An accelerometer or a set of accelerometers 2-4 providing directions in three dimensions can also be located within the smart phone 2-4 and coupled to the processor by interface 2-5. The touch screen 2-7 may be a sub-set of the screen 1-14 and can be sensitive to a finger touch sending the response via interface 2-6. For audio input and output response, an earphone and a speaker 2-12 can couple audio to/from the processor by 2-13 and for visual input, a camera 2-11 can provide input to the processor via interface 2-10. Lastly, the processor can couple externally through a wireless means 2-9 by the interface 2-8. Additionally there can be other features within the smart phone that may not be listed here, as for example; power supplies, batteries and other such units which are very typical of smart phones but not illustrated to simplify the complexity of the diagram.

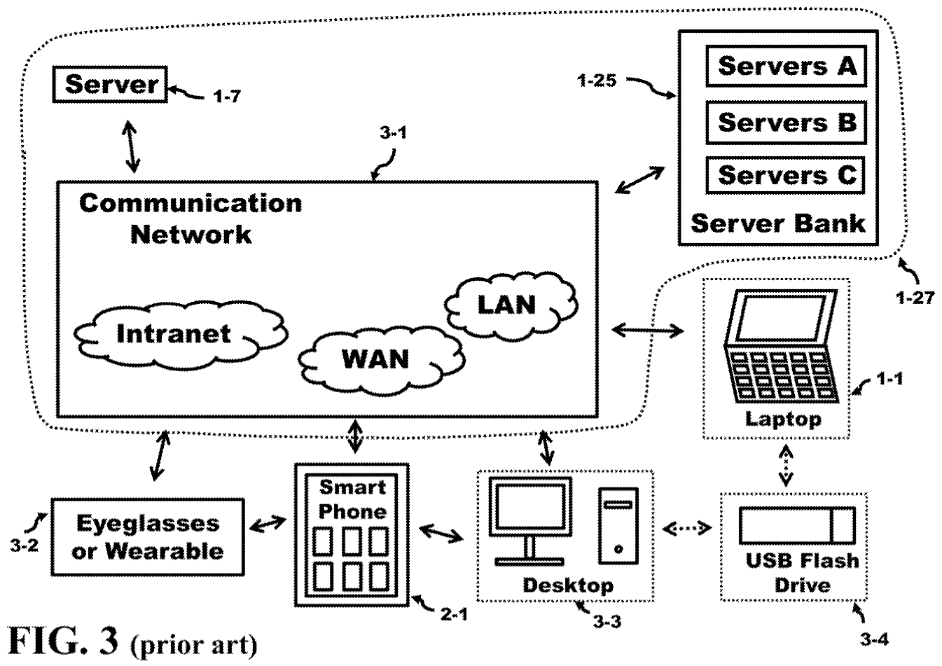

FIG. 3 shows the Internet 1-27 with various components within the Internet. These components include the communication network 3-1 which includes some components, such as, the intranet, WAN, and LAN. The communication network is coupled to server 1-7. It is also coupled to a server bank 1-25. The Internet is vast and contains many devices that are not presented here. The Internet connects us all together allowing those who have access to the Internet to share our thoughts and data with all those who are coupled to the Internet. Various devices can couple to the Internet 1-27. Some of these devices include eyeglasses or wearables 3-2, smart phone 2-1, desktop 3-3, laptop 1-4, and a USB flash drive 3-4 coupled to either the desktop or the laptop.

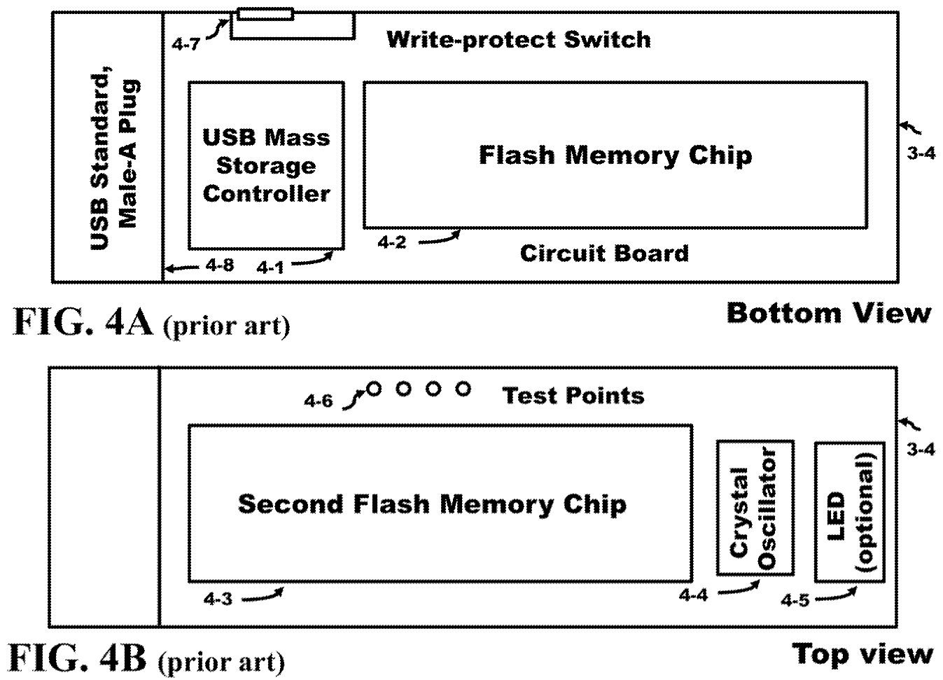

FIG. 4A illustrates a bottom view block diagram of a memory stick 3-4. Within the memory stick, is a flash memory chip 4-2, a USB mass storage controller 4-1, a USB standard Male-A plug 4-8, and a right protect switch 4-7. A top view of the memory stick is presented in FIG. 4B. Within the memory stick, there could be a second flash memory chip 4-3 for additional storage, test points 4-6 to test the device, a crystal oscillator 4-4 for timing, and an LED to indicate the presence of a function that is optional 4-5. The crystal oscillator generates a sinusoidal signal that's used for timing, while the mass storage controller controls the memory access of the flash memory chips.

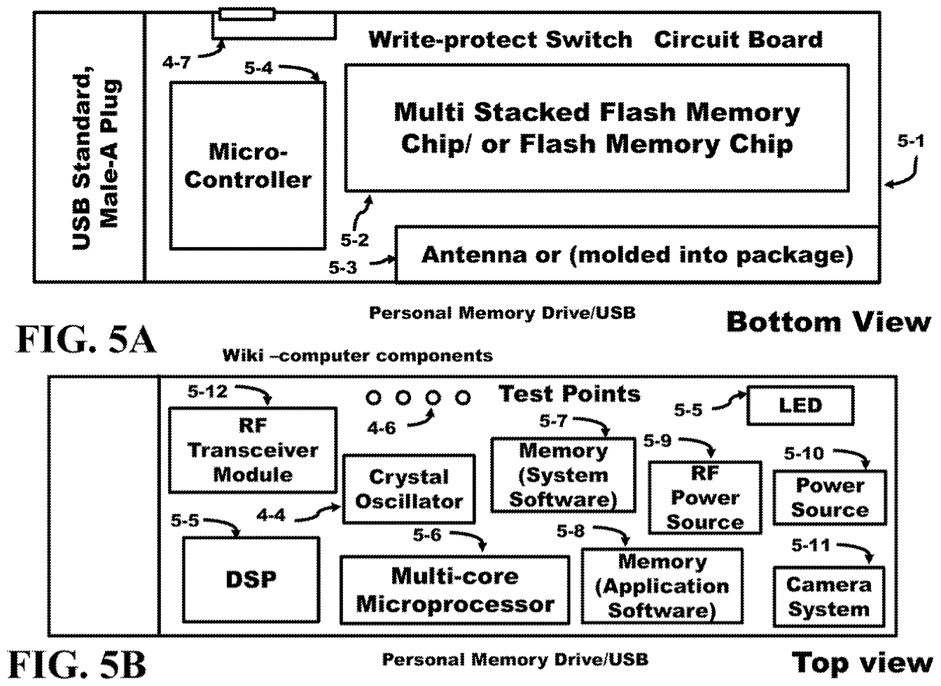

FIG. 5A depicts the bottom view of a Personal Memory Drive 5-1 that contains a microcontroller 5-4, a right protect switch 4-7, a multi stacked flash memory chip/or flash memory chip 5-2, and at least one antenna that can be molded into the package 5-3. The multi-stack flash memory chip can contain several memory chips stacked on one another with wire bonds or solder bumps connecting each of the individual chips together within a molded package. The antenna allows for wireless interface communications between the Personal Memory Drive and an outside destination.

FIG. 5B presents the top view of a Personal Memory Drive that can contain an RF transceiver module 5-12, a DSP 5-5, crystal oscillator 4-4, a multicore multiprocessor 5-6, a memory (system software) device 5-7, memory (application software) 5-8, a RF power source 5-9, a camera system 5-11, a power source 5-10, and an LED 5-5. The RF transceiver module interfaces with the antenna 5-3 to allow the Personal Memory Drive to communicate with other devices wirelessly. The multicore processor and the DSP work together to detect voices translate voices to text, translate text to audio, and many other applications which are required in order to operate the Personal Memory Drive. Some of the features of this device include the ability to perform searches, control local computers, interact with the user, and interact with other Personal Memory Drives. The memory is driven by system software and application software. The camera system uses a CMOS camera to detect images. This Personal Memory Drive has all the components necessary for it to behave very similar to a personal computer packed within the size approximating that of a memory stick.

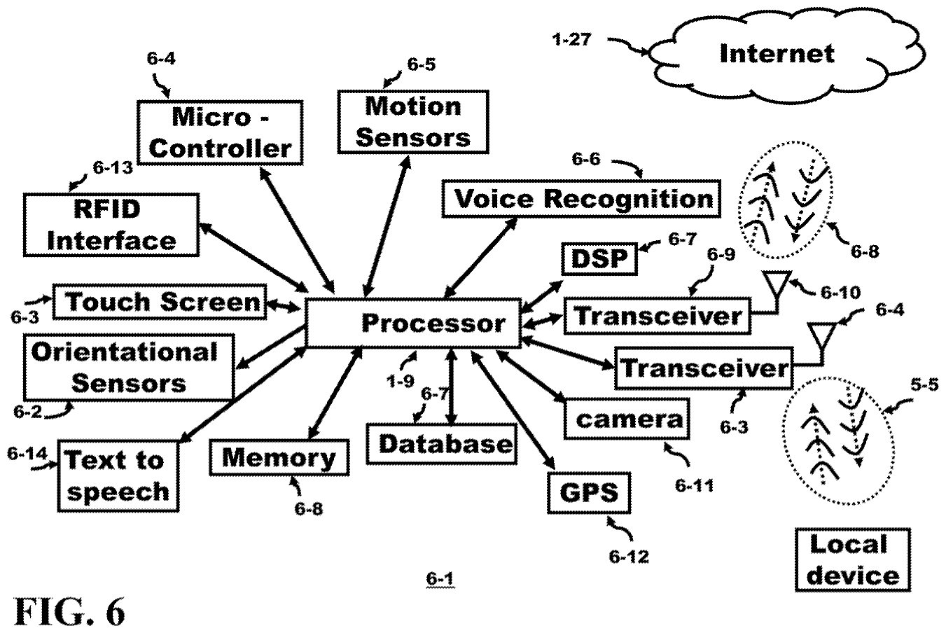

FIG. 6 illustrates a block diagram of the Personal Memory Drive 6-1. The processor 1-9 which could be a multiprocessor along with the DSP mentioned earlier couples to a number of components. Some of these components include a text to speech capability 6-14, orientation sensors 6-2 which allow for acceleration measurements as well providing the orientation or position of the Personal Memory Drive, a touchscreen 6-3, a RFID interface to communicate to a RFID strip 6-13, a microcontroller 6-4 which can be used in conjunction with the processor, additional motion sensors 6-5, a voice recognition system 6-6 that works with the DSP 6-7, memory 6-8 which represents all of the memory within the chip, a database 6-7 that uses the memory to define different databases, a global positioning system (GPS) 6-12, a camera 6-11 and one or more transceivers which have a transmitter/receiver coupled to antennas 6-10 and 6-4. At least one transceiver 6-9 interfaces the Internet through a communication link 6-8. The same or a second transceiver 6-3 can communicate with an antenna 6-4 over a communication link 5-5 to a local device.

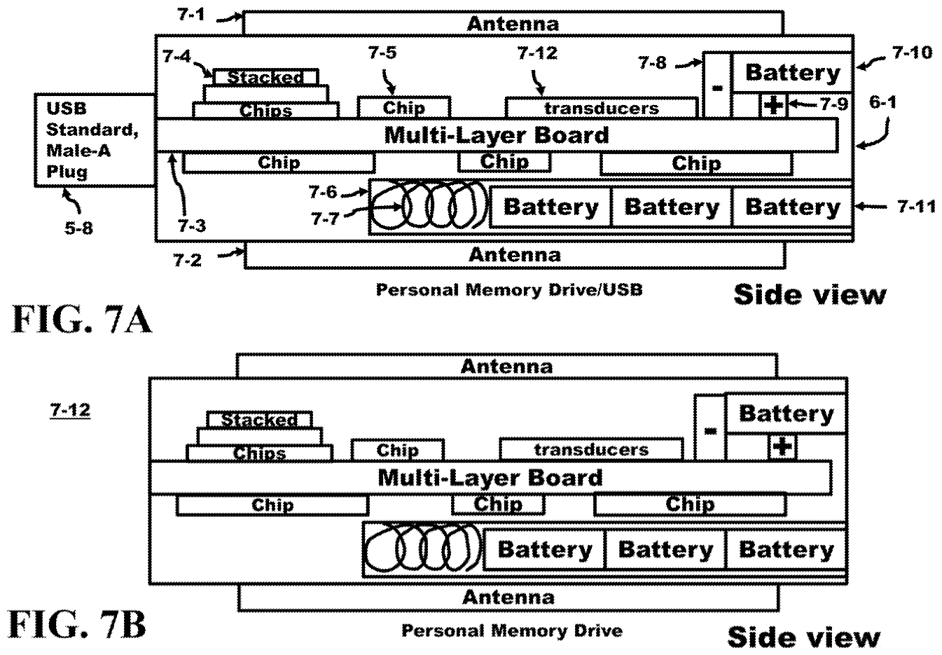

A cross-sectional view of a Personal Memory Drive 6-1 is presented in FIG. 7A. The Personal Memory Drive has a multilayer board 7-3 which has traces on it interconnecting batteries, and chips together. The battery 7-10 can be a rechargeable battery wherein once the USB plug is inserted into a PC, the battery gets recharged. In 7-4 is a stacked chip configuration that corresponds to the stacked memory mentioned earlier. The stacked chip configuration can contain memory, or other circuits. In addition there are chips 7-5 populating the multilayer board with connections to a battery 7-10 the connections are 7-8 and 7-9 which couples the battery to the board and provide power to the Personal Memory Drive. Transducers 7-12 are also coupled to the board. The transducers are configured to sense voltage, electromagnetic, electrochemical, electromechanical, electroacoustic, or electro-optical signals. Antennas 7-1 and 7-2 interfaces with the RF chips onboard to allow this device to communicate wirelessly to other devices or the Internet. The Personal Memory Drive can also store additional batteries 7-11 within the cavity 7-6 which could be spring-loaded 7-7. These batteries can be extracted and replaced within the battery position 7-10 to ensure that power is available for the Personal Memory Drive over an extended period of time.

A second cross-sectional view of a different version of a Personal Memory Drive 7-12 is illustrated in FIG. 7B. This Personal Memory Drive lacks the USB standard Male-A plug. One source of power will be the battery 7-10 and battery pack 7-11. Otherwise the components within this Personal Memory Drive are very similar to that what was given in 6-1.

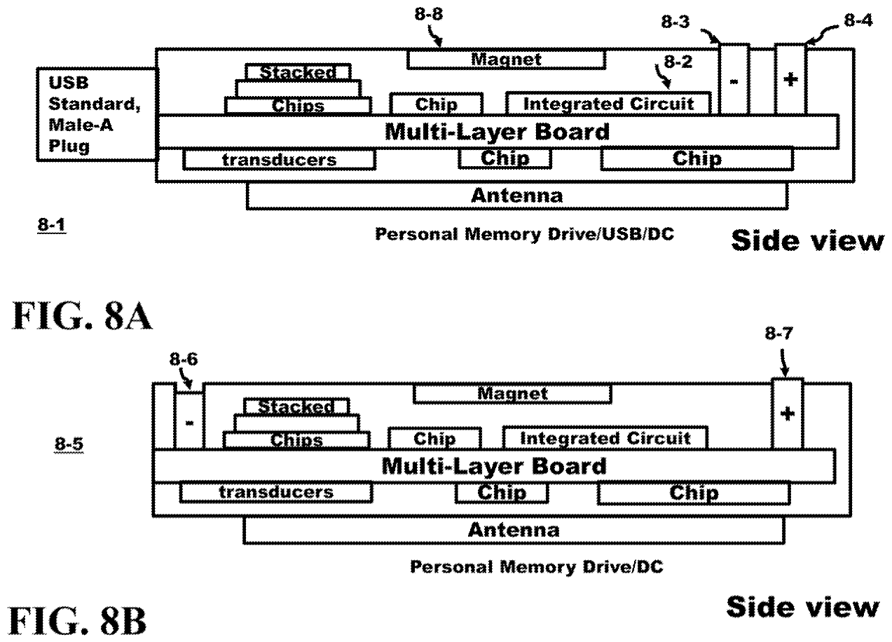

The Personal Memory Drive 8-1 presented in FIG. 8 a lacks the batteries presented earlier. However the leads to the multilayer board to power the device 8-3 and 8-4 can extend from the body of the Personal Memory Drive device. A magnet 8-8 is molded into the body of the device. Some of the chips mentioned earlier can be integrated circuits 8-2. Another embodiment of the Personal Memory Drive is illustrated in FIG. 8B. The powering system to this device is also different in that the negative power lead 8-6 is recessed while the positive power lead 8-7 extends above the body of the device. Both of the devices 8-1 and 8-5 lack batteries and require a power source. The Personal Memory Drive 8-1 can be coupled to a PC which can provide power.

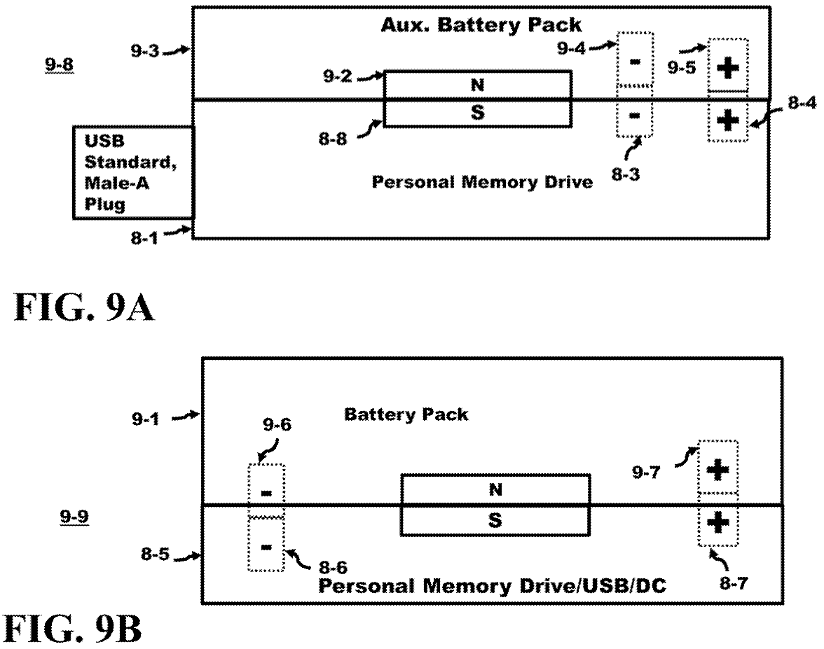

FIG. 9A illustrates how an auxiliary power battery pack 9-3 can be coupled to the Personal Memory Drive 8-1. The auxiliary battery pack contains at least one magnet 9-2 of opposite polarity that is matched in pattern to the magnets positioned on the Personal memory drive. The recessed power contacts 9-4 and 9-5 couple to the extended power contacts 8-3 and 8-4. The opposite poles of the magnet attracts the auxiliary battery pack to the Personal Memory Drive and the positioning of the power leads allows the extended components of the power leads on the Personal Memory Drive to fit within the recessed regions of the auxiliary battery pack such that the power from the battery pack can be applied to the Personal Memory Drive. In FIG. 9B, a battery pack 9-1 couples to the Personal Memory Drive 8-5. One of the power supplied leads is recessed while the second one is extended. This allows battery pack to interface to the Personal Memory Drive where the negative connection 9-6 of the battery pack and the positive connection 9-7 interfaces with the corresponding power supply leads of the Personal Memory Drive 8-5. Many other positions and locations for the magnets and power leads are possible.

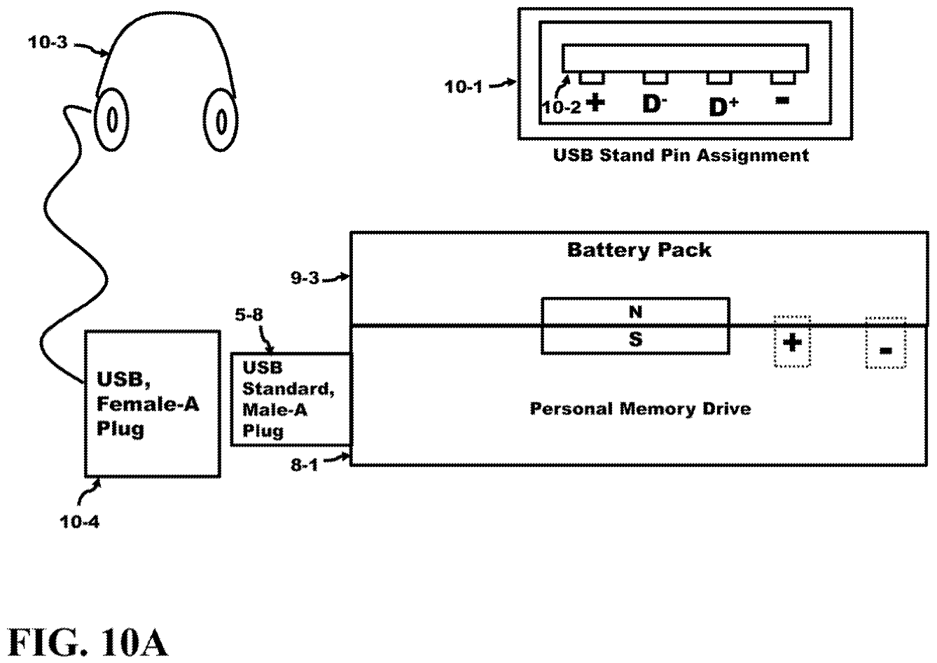

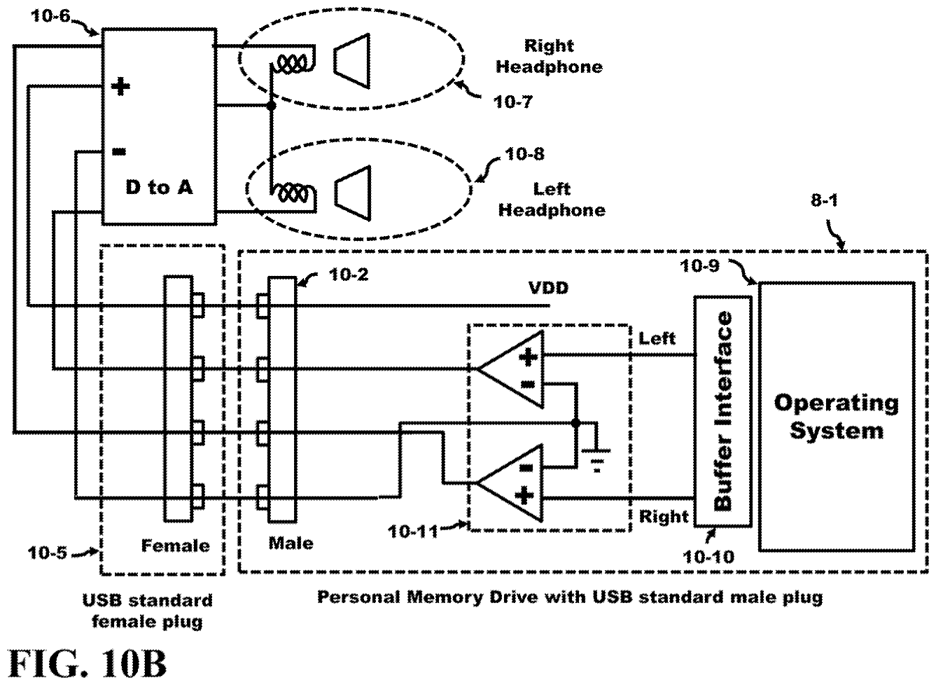

The Personal Memory Drive systems can be used for many different functions. One embodiment illustrated in FIG. 10A presents the Personal Memory Drive being used to provide music to a pair of headsets 10-3. The headset can be wired to a USB standard female—a plug 10-4 which couples to the USB standard mail a plug 5-8. The USB standard pin assignment is illustrated in 10-1. The footprint 10-2 illustrates a positive connection, a data negative connection, the data positive connection, and a negative power supply. In FIG. 10B, a schematic diagram of the interface to the right headphone 10-7 and the left headphone 10-8 is presented. Within the Personal Memory Drive 8-1 the operating system 10-9 interfaces with the buffer interface 10-10 and present the audio database containing music, voice, etc. to the headset. The buffer interface provides a left and right channel of the audio signal which is provided to an amplifier 10-11. The amplifiers in 10-11 are differential and provide an output signal through the male plug 10-2 on the positive and negative leads. The male plug interfaces to the female plug and provides the audio signals to a digital to analog converter 10-6. The analog signal exiting from the D/A 10-6 is applied to the right and left headphone's. This allows the operating system of the Personal Memory Drive to manipulate the audio signal stored within the memory devices and present that audio signal to the user on the right and left headphones providing the user with audio.

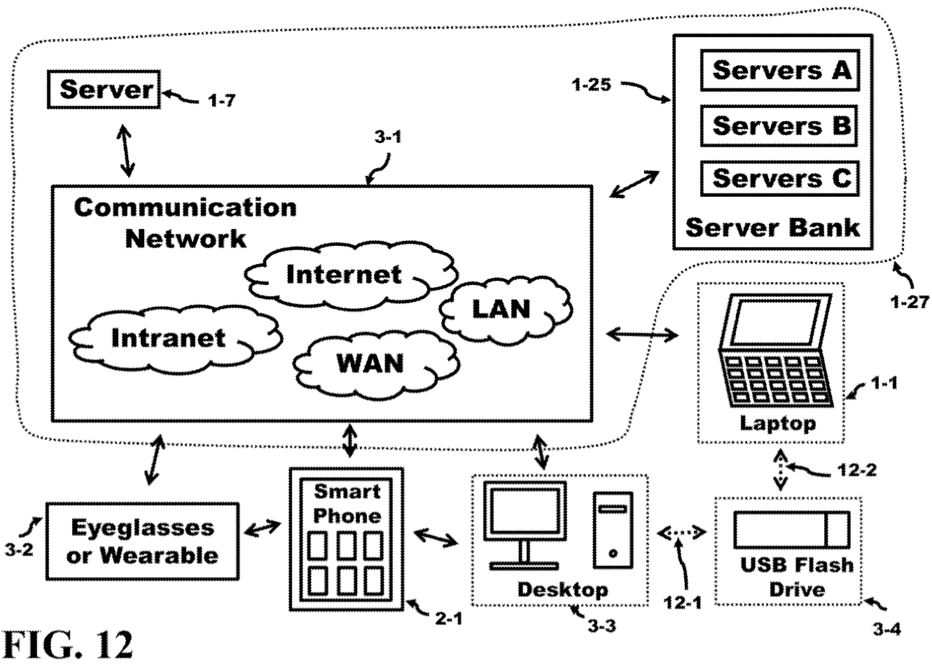

FIG. 12 shows the Internet 1-27 with the various components within the Internet. These components include the communication network 3-1 which includes the intranet, Internet, WAN, and LAN. The communication network is coupled to server 1-7. It is also coupled to a server bank 1-25. Various devices can couple to the Internet 1-27. Some of these devices include eyeglasses or wearables 3-2, smart phone 2-1, desktop 3-3, laptop 1-1, and a USB flash drive 3-4 coupled to either the desktop or the laptop. The conventional USB Flash drive couples to a computation device such as a desktop or laptop to store data or provide data to the computation device (laptop, desktop, or some type of computer). The flask drive does not communicate directly with the Internet.

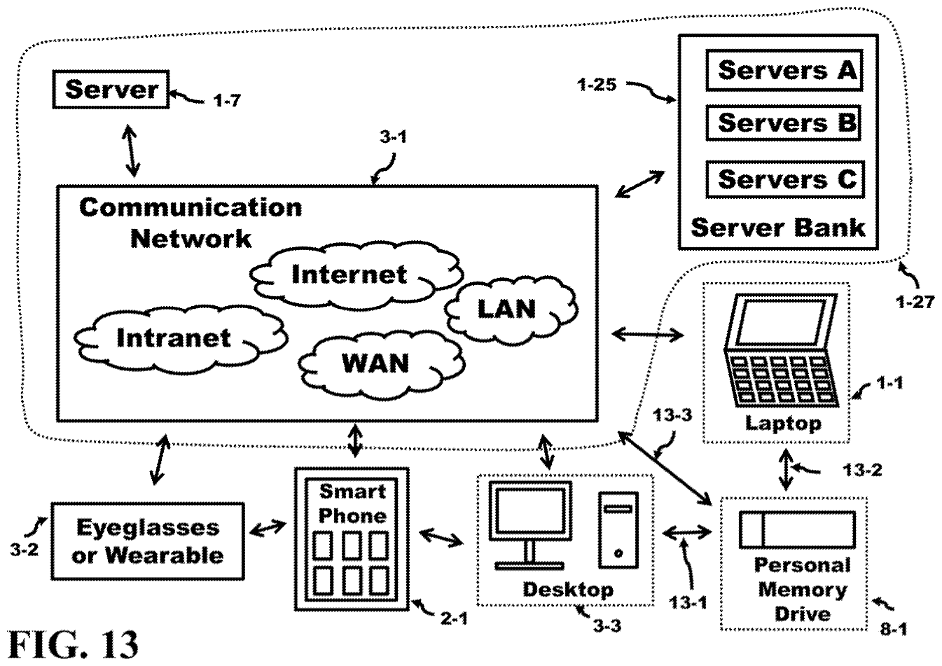

FIG. 13 shows the Internet 1-27 with the various components within the Internet similar to that shown in FIG. 12. The exception being that the Personal Memory Drive 8-1 can connect directly to the Internet 1-27. In addition, the Personal Memory Drive 8-1 can couple to either a desktop 3-3 or the laptop 1-1 through communication links 13-1 and 13-2, respectively. The Personal Memory Drive 8-8 communicates over the link 13-3 with the Internet. The wireless interface of the Personal Memory Drive 8-1 is not limit the communication link to a laptop or desktop since the wireless link and the operating system within allows the Personal Memory Drive to communicate with the Internet. In addition, the wireless capability allows the Personal Memory Drive to communicate with a smart phone 2-1, or eyeglasses or wearable devices 3-2 and any other electronic device that a user may use although it is not illustrated in this particular figure.

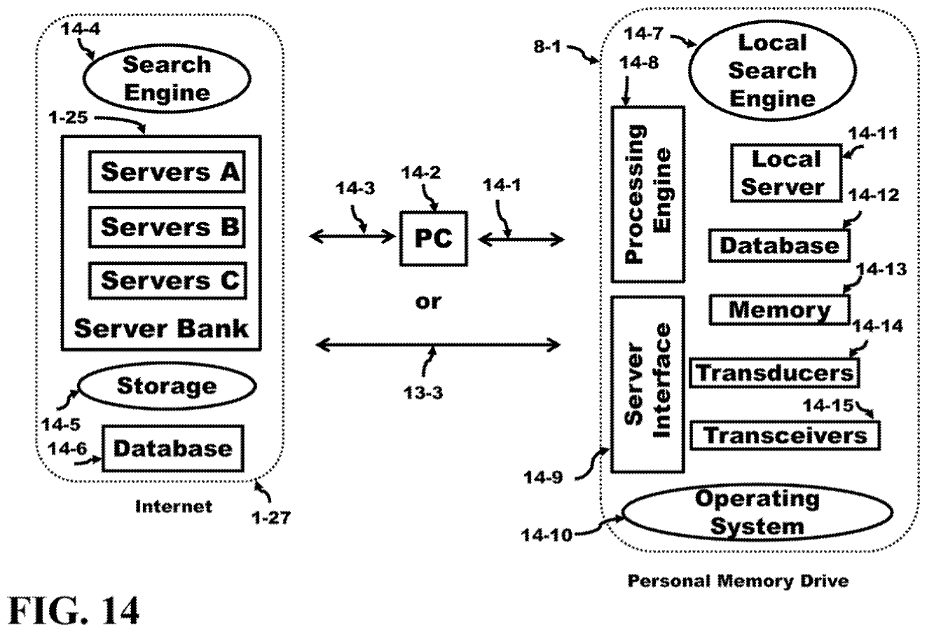

FIG. 14 illustrates a block diagram of the Internet 1-27 interfacing through a personal computer (PC) 14-2 via the links 14-3 and 14-1 or communicating directly with the Personal Memory Drive 9-1 via link 13-3. These links are typically wireless interfaces and can carry communications in the bidirectional direction. The Internet 1-27 can contain a multitude of search engines 14-4, a bank of servers 1-25, various databases 14-6, and additional storage capabilities 14-5. The Personal Memory Drive 8-1 can contain a local search engine 14-7, with a local server 14-11, having a database 14-12, with at least one memory 14-13, transceivers 14-15 to interface wirelessly, one of more operating systems 14-10, a server interface 14-9, and a processing engine 14-8. The server interface 14-9 allows the Personal Memory Drive to couple directly to the Internet. The operating system 14-10 is flexible and allows the Personal Memory Drive to communicate directly 13-3 with the Internet or couple to a local PC 14-2 through a communication link 14-1 which is a wireless connection formed by one of the transceivers 14-15. The memory 14-13 can be composed of various types of memories that are well known in the art such as RAM, ROM, flash memory, DRAM, content addressable memory, DDR SDRAM's, or SRAM's. The transducers are devices that sense or create a presence of the signal. These transducers can be electromagnetic such as antennas, Hall effect sensors, magnetic tape interfaces. The transducers can be electrodes measuring voltage (for example, brain waves); electrochemical sensing chemicals in the environment; can be electromechanical measuring strain, touch, acceleration, position, or airflow. The transducers can be electroacoustic such as an earphone, a loudspeaker, microphone, piezoelectric crystal, or an ultrasonic component. In addition the transducer can be electro-optical which would include light emitting diodes, laser diodes, photo resistors and photo transistors. The transceivers can be used to communicate using various protocols of the IEEE. Some of these would be the 802.11, Bluetooth, Wi-Fi, WiGig, 3G, 4G, 5G or LTE. The local search engine will be used to search the memory or databases within the Personal Memory Drive. The memory 14-13 can be partitioned into various databases 14-12 that can interface with the operating system 14-10. The local search engine 14-7 can be used to search the databases as they are partitioned within the Personal Memory Drive. The processing engine can be a microprocessor, a multi-core microprocessor, a microprocessor with an embedded DSP, or a microprocessor with an memory access device.

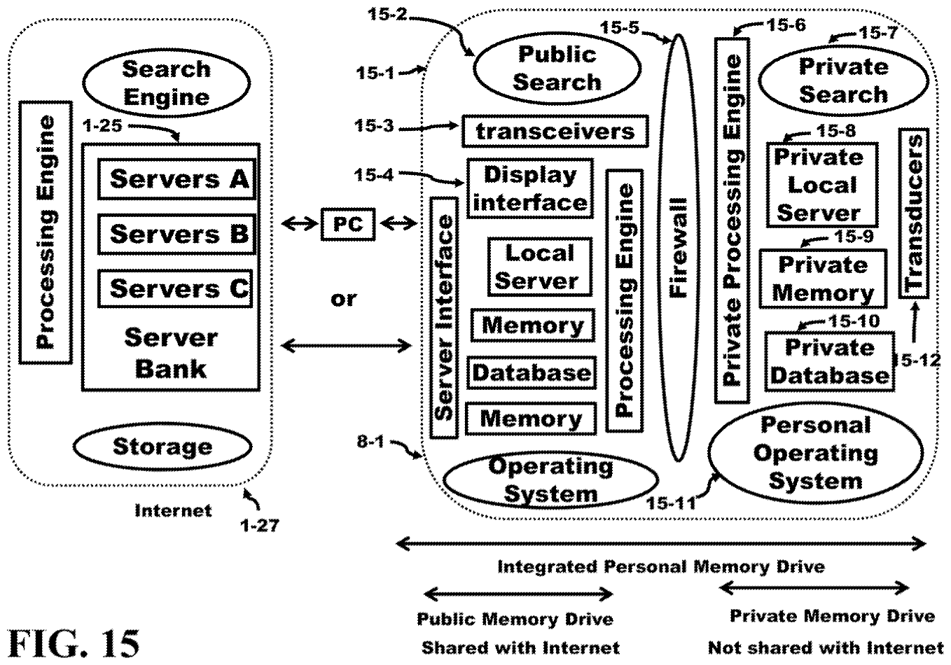

FIG. 15 illustrates a further refined block diagram of the Personal Memory Drive. The Personal Memory Drive has been divided into a Public Memory Drive and a Private Memory Drive. Both of these memory drives are integrated within the Personal Memory Drive 8-1. The Public Memory Drive is shared with the Internet while the Private Memory Drive is not directly shared with the Internet and typically shielded from the Internet by a firewall 15-5 and the Public Memory Drive. The Public Memory Drive contains a public search engine 15-2, transceivers 15-3, can have a display interface 15-4, similar components as presented earlier, such as, the local server, memory, databases, a server interface, and operating system, and a processing engine. The Private Memory Drive can contain a private search engine 15-7, private server-eight, a private memory 15-9, a private database 15-10, a private processing engine 15-6, and a personal operating system 15-11. Transducers 15-12 can be shared within the Personal Memory Drive 8-11. The firewall 15-5 segregates the Public Memory Drive from the Private Memory Drive. This allows the Private Memory Drive with its private components to be isolated from the Public Memory Drive and further isolated from the Internet. The Private Memory Drive is geared to be modeled after the user who owns the Private Memory Drive. These are some of the memories that the user wants to keep intact and only known to the user. The private database and private memory store information of the user that the user may not want known to any other user. The firewall 15-5 helps to isolate the private section from the public section. The Public Memory Drive, however, interfaces to the Internet and to the Private Memory Drive.

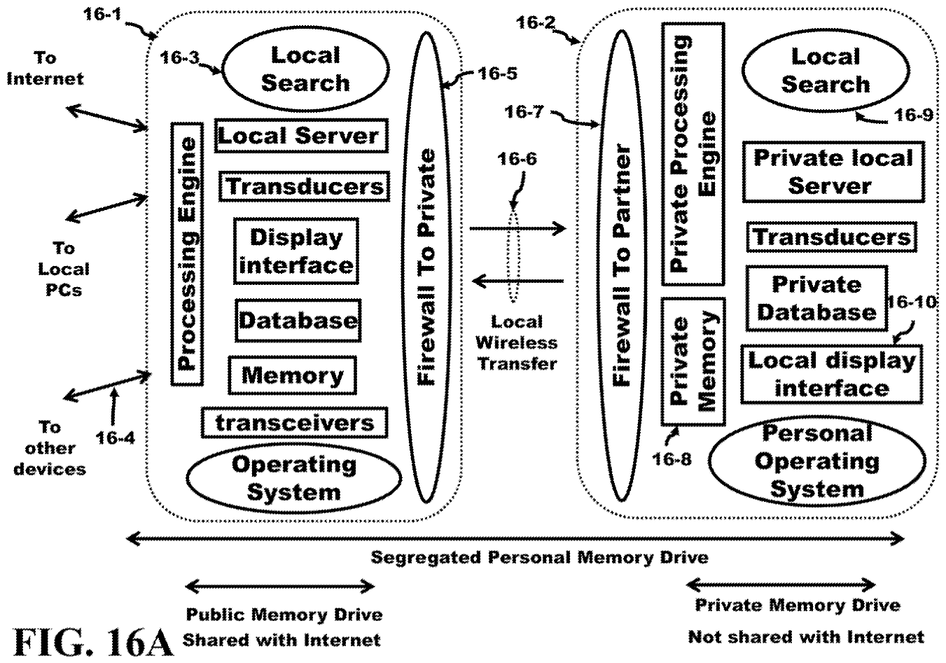

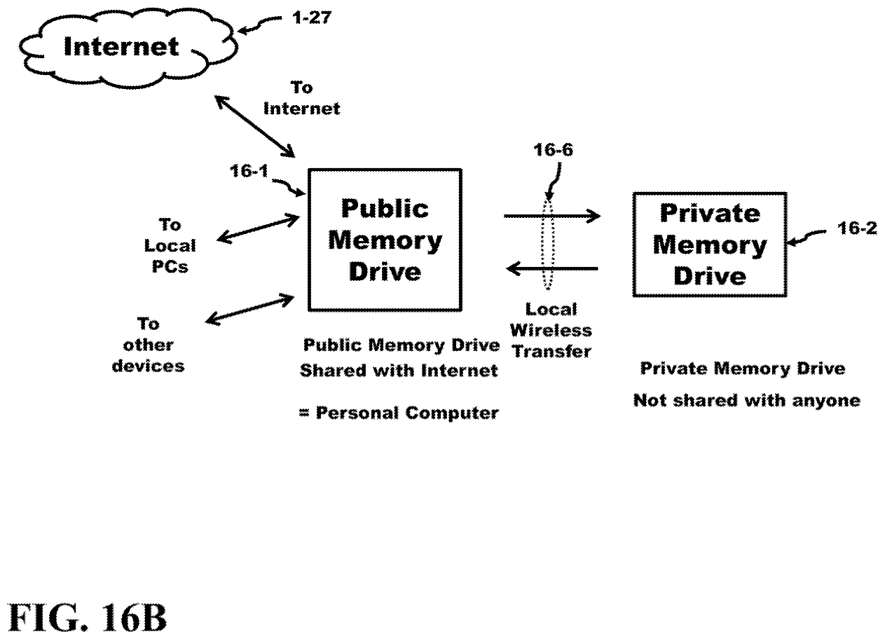

The Personal Memory Drive has been segregated in FIG. 16A into two separate units or devices. The Public Memory Drive 16-1 interfaces the Private Memory Drive 16-2 to other devices, the local PCs, and to the Internet. The Public Memory Drive 16-1 has a local wireless interface 16-6 to the Private Memory Drive. The Private Memory Drive 16-2 contains a firewall to its partner 16-7 a private memory 16-8, a local search engine 16-9 possibly a local display interface 16-10, and some of the previous components the Private Memory Drive section contained such as the private local server, transducers, private database, the personal operating system, and the private processing engine. The Public Memory Drive 16-1 contains its own local search engine 16-3, and similar components contained when both devices were combined. These include the local server, transducers, display interface, database, memories, transceivers, operating system, and the processing engine. The firewall to the private device 16-5 interfaces wirelessly to the firewall to partner 16-7 allowing access to the Private Memory Drive. The Public Memory Drive can interface to other devices overall wireless interface 16-4, communicate to local PCs wirelessly or through a USB connector (if present), or communicate wirelessly to the Internet. Each device has its own operating system and can be tailored to the individual user.

FIG. 16B depicts a higher level perspective of how the Private Memory Drive 16-2 can be coupled to a Public Memory Drive 16-1 performing as a PC. The Public Memory Drive 16-1 has all the components to make this component behave as a personal computer. Here the Internet 1-27 couples to the Public Memory Drive 16-1. The Public Memory Drive behaving as a PC also can interface to other PCs and other devices. The Private Memory Drive 16-2 is shared over a local wireless transfer 16-6 to the Public Memory Drive.

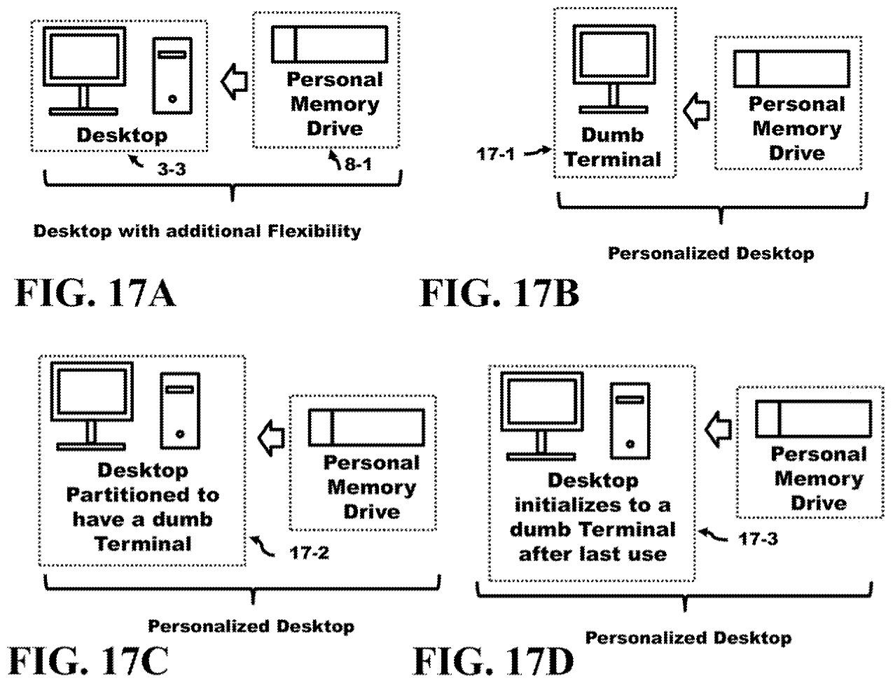

FIG. 17A illustrates a desktop 3-3 with additional flexibility when coupled to a Personal Memory Drive. The desktop interfaces to the Personal Memory Drive 8-1 where the Personal Memory Drive can interact with the operating system of the desktop to allow the desktop to become more personalized to the user of the Personal Memory Drive. The desktop is modified according to instructions provided by the Personal Memory Drive. In FIG. 17 B, the Personal Memory Drive can interface directly with a dumb terminal 17-1 to make the dumb terminal behave as a personalized desktop that can interface with other PCs are with the Internet. If a first user removes his Personal Memory Drive from the dumb terminal, and a second user places his Personal Memory Drive into the dumb terminal, the dumb terminal is tailored to the second user where the dumb terminal becomes tailored to each one of the users. FIG. 17C illustrates a desktop partitioned to have a dumb terminal 17-2. The Personal Memory Drive interfaces to the dumb terminal and modifies the desktop becoming a personalized desktop for the user. FIG. 17D illustrates another personalized desktop. In this case, the desktop initializes to a dumb terminal after its last use 17-3. When a user leaves and removes their Personal Memory Drive, the desktop initializes to a dumb terminal waiting until a new user arrives. Each time a new user enters their Personal Memory Drive into the desktop, the desktop initializes and removes all previous conditions, if not done already, becoming a dumb terminal allowing the Personal Memory Drive that is being inserted or coupled wirelessly to the unit to respond to the commands of the Personal Memory Drive causing the desktop to become personalized after automatically being initialized when the last user remove their Personal Memory Drive device from the desktop.

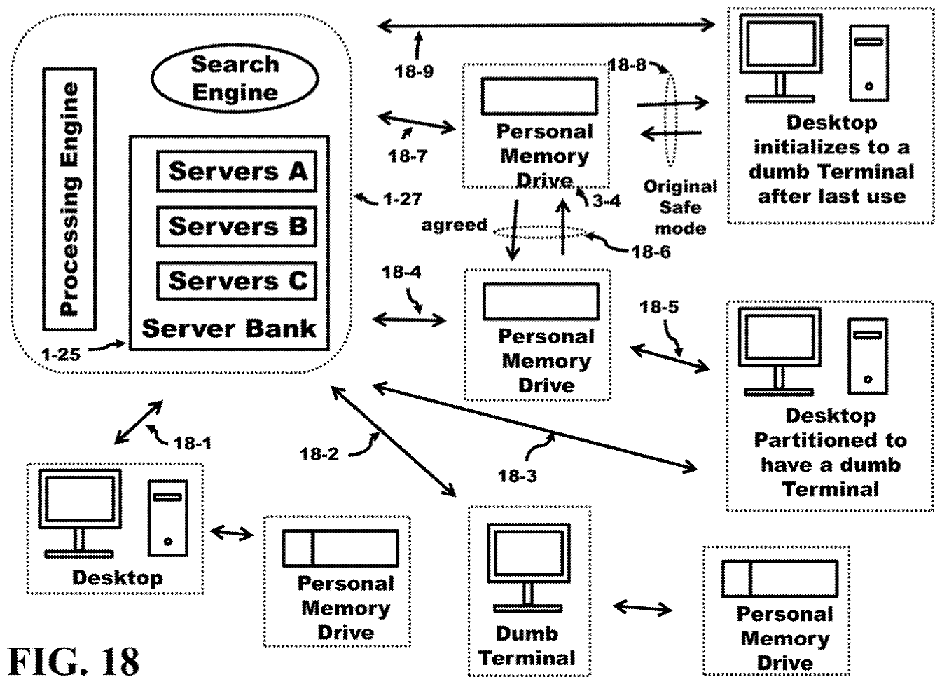

FIG. 18 illustrates the Internet 1-27 coupling with the various versions of desktops mentioned earlier after being coupled to a Personal Memory Drives. For the wireless connection 18-1, the desktop coupled to the Personal Memory Drive creates a personalized desktop coupled to the Internet. On the bidirectional connection 18-2, the dumb terminal is controlled by the Personal Memory Drive. The dumb terminal becomes the equivalent of the user's computer that he may have at home. The dumb terminal is tailored to have the entire interface and operating system (iOS, Windows, Linux) after being coupled to the Personal Memory Drive. Over the communication link 18-3, a desktop partitioned to have a dumb terminal is coupled to a Personal Memory Drive 18-3 over a second interconnect 18-5. In addition, the same Personal Memory Drive can couple directly to the Internet over the interconnect 18-4. In the upper right, a desktop that is initialized to a dumb terminal after its last use communicates with a Personal Memory Drive over the interface 188. The personal drive can communicate directly with the Internet over the interface 18-7 and if there's an agreement between the two Personal Memory Drives, the two memories can exchange information over the link 18-6.

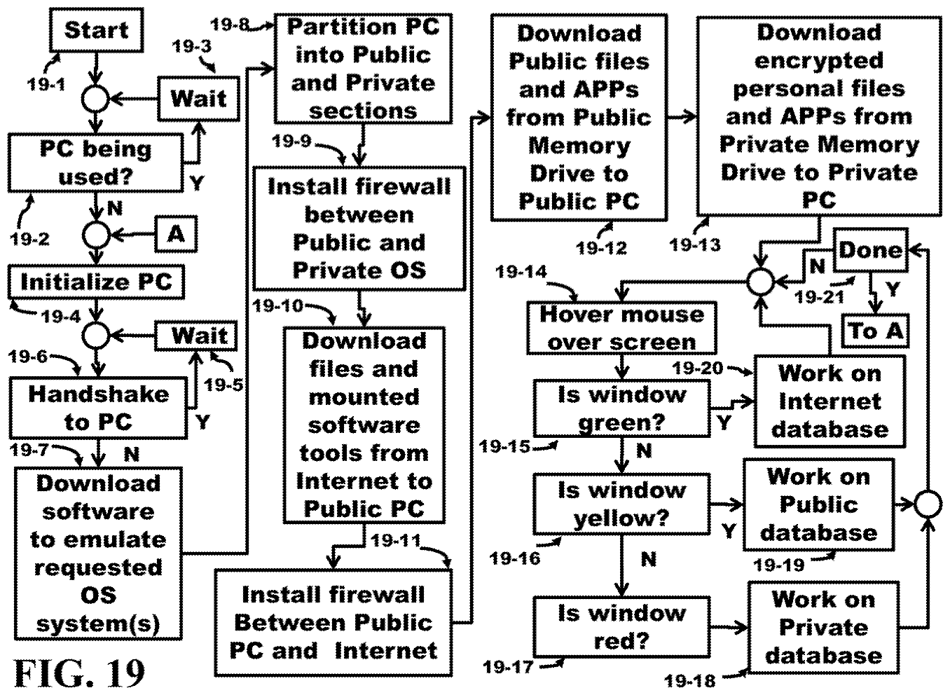

FIG. 19 illustrates a flow chart of how a Personal Memory Drive can be used to initialize a PC. The Personal Memory Drive starts at 19-1, then it proceeds to see if the PC is being used 19-2. If it is, wait 19-3 and check again. If not, at this point, the PC is initialized 19-4. The initialization process can be controlled by the PC knowing that the Personal Memory Drive has been removed by the previous owner and causes the PC to forget any transactions that occurred in the previous handshake. All databases associated with the previous handshake are erased and replaced with initial values; any applications (APPS) that were downloaded are removed; the PC is returned to a state that is equivalent to a newly purchased PC (the PC also has an improved performance); all memories (electronic or magnetic), or references to, that were written in the previous handshake can overwritten with random data. The registries are deleted. The handshake is a protocol wherein the Personal Memory Drive and the PC recognize the presence of each other. After the completion of the handshake, both devices have all the necessary data to from and establish a communication channel. After initialization, a handshake with a new Personal Memory Drive can occur 19-6. Wait 19-5 until handshake is complete. The newly inserted Personal Memory Drive of the new user downloads software to emulate the requested operating system desired by the user 19-7. The registries are set with new data to function the PC as the new owner desires based on the contents of the Personal Memory Drive. The operating system can be iOS, windows, Linux or any OS the user has stored in their Personal Memory Drive. The PC can be partitioned into a public and private section 19-8 and doing so a firewall is installed between the public and private operating systems within the PC 19-9. Files are downloaded from the Internet which mount software tools to the public portion of the PC 19-10 and the firewall is installed between the public PC and the Internet 19-11. Public files and applications residing on the Public Memory Drive of the Personal Memory Drive are downloaded to the public portion of the PC 19-12. The private portion of the PC is then downloaded with encrypted personal files and applications from the Private Memory Drive of the Personal Memory Drive 19-13. The PC now is behaving under the control of the Personal Memory Drive and has characteristics that the user implemented into the Personal Memory Drive which is currently reflected in the operating system that has been temporarily installed on the PC. Visual cues are provided on the display of the PC that shows which database (Internet, local, or private) is being operated on. The user searches for the mouse on the screen 19-14 and places the mouse in one of the window portions and if the screen turns a certain color, the color can be related to the database type. For example, if the window portion becomes green 19-15, this allows the user to work on the Internet database 19-20. By hovering the mouse over a portion of the screen having a different color, for example, yellow 19-16, then the user can work on the public database 19-19. The public database can be available to other users who are selected by the user. By moving the mouse are hovering the mouse over yet another color, for example, red 19-17, then the user would be working on files or memory database corresponding to the private database 19-18. The private database is available only to the user. If the user is not the done 19-21, the user can move into the different regions on the display screen to perform different functions on the different partitions within the Personal Memory Drive or on a database within the Internet. Otherwise, if the user is finished they can end the function and move to A. Other ways of displaying access to the database can include text, sounds, to print the status of which database is being operated on.

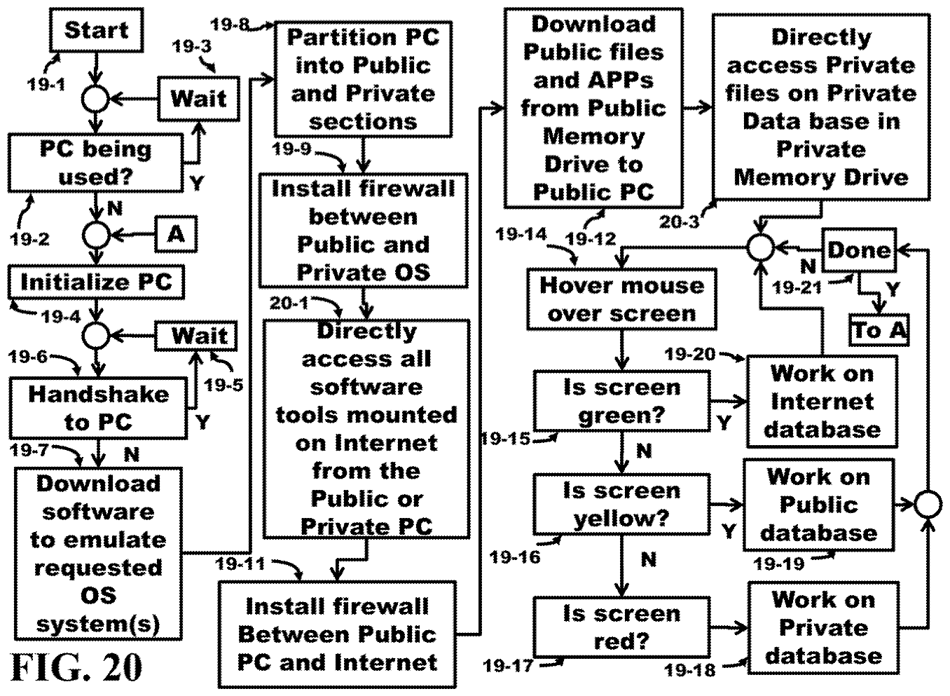

FIG. 20 is another flowchart which shows the interaction between the Personal Memory Drive and the PC. This interaction is different than the interaction provided in FIG. 19, wherein the block 20-1 can directly access all software tools mounted on the Internet from either the public or the private portion of the PC. In addition this interface can directly access the private files on the private database in the Private Memory Drive 20-3 and this can be done directly from the keyboard of the PC. The firewalls that have been installed in blocks 19-9 and 19-11 contain all of the necessary software to ensure that the integrity of the system is maintained such that the private portion of the PC is maintained private.

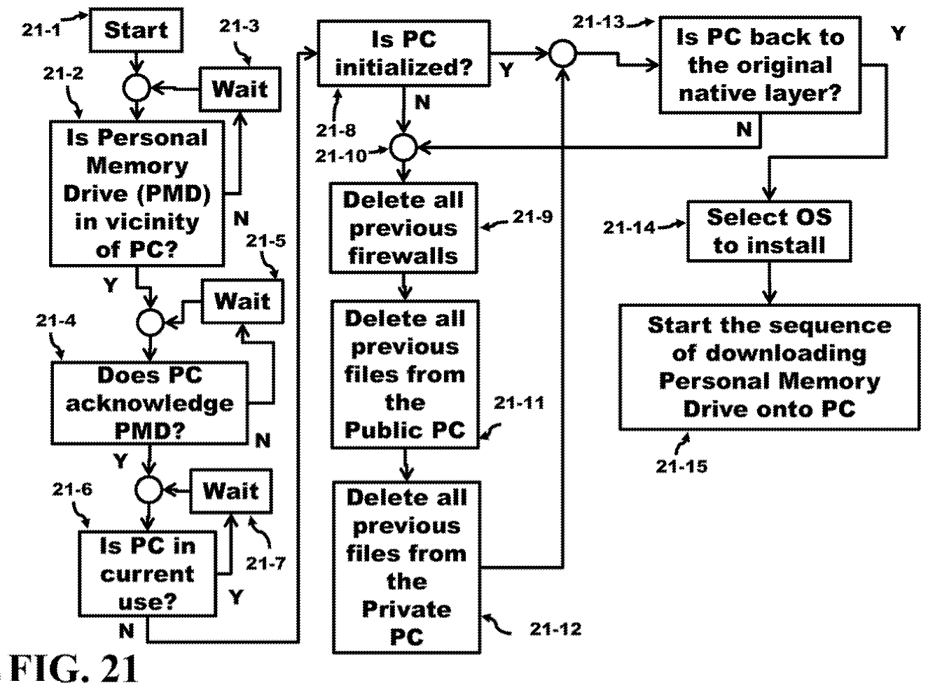

The flowchart in FIG. 21 illustrates how a PC is initialized when a Personal Memory Drive senses a PC in its environment. At start 21-1, the process flows to is Personal Memory Drive in vicinity of PC 21-2. If not, wait 21-3. Otherwise, determine if the PC acknowledges the PMD 21-4 and wait 21-5 if the PC does not acknowledge. In 21-6, it's determined if the PC is in current use and if so wait 21-7, otherwise, find if the PC is initialized 21-8. Typically, the PC self-initiates after the previous user leaves, but if the PC has not been initialized, then delete all previous firewalls 21-9 public portion of the PC 21-11, then moved to 21-13. Is the PC back in its original native layer, if not moved to 21-10 and repeat previous steps. If the original native layer exists on the PC, select the operating system to install 21-14 and start the sequence of downloading Personal Memory Drive components onto the PC 21-15.

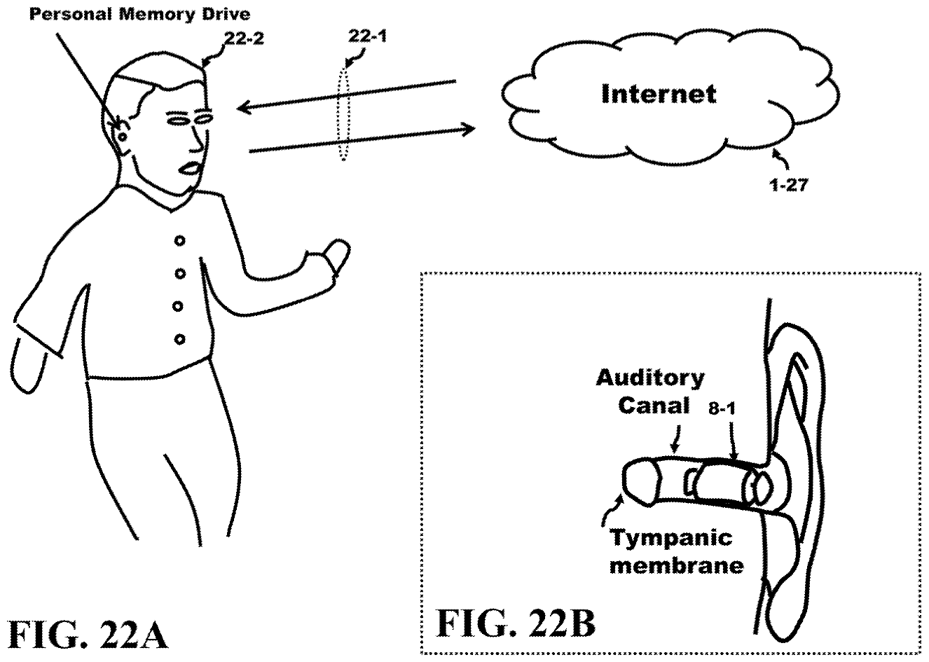

FIG. 22A illustrates the Personal Memory Drive inserted into an ear canal of a user 22-2. The Personal Memory Drive is in contact with the Internet 1-27 through the bi-directional communication link 21-1. Integrate circuit continue to follow Moore's law of scaling allowing a greater density of circuit to be embedded into the integrated circuit. This integration allows for the miniaturization of the Personal Memory Drive. In FIG. 22B, the Personal Memory Drive 8-1 is illustrated inserted inside of the ear canal. The Personal Memory Drive can be embedded into the ear canal such that it may not be visible to others.

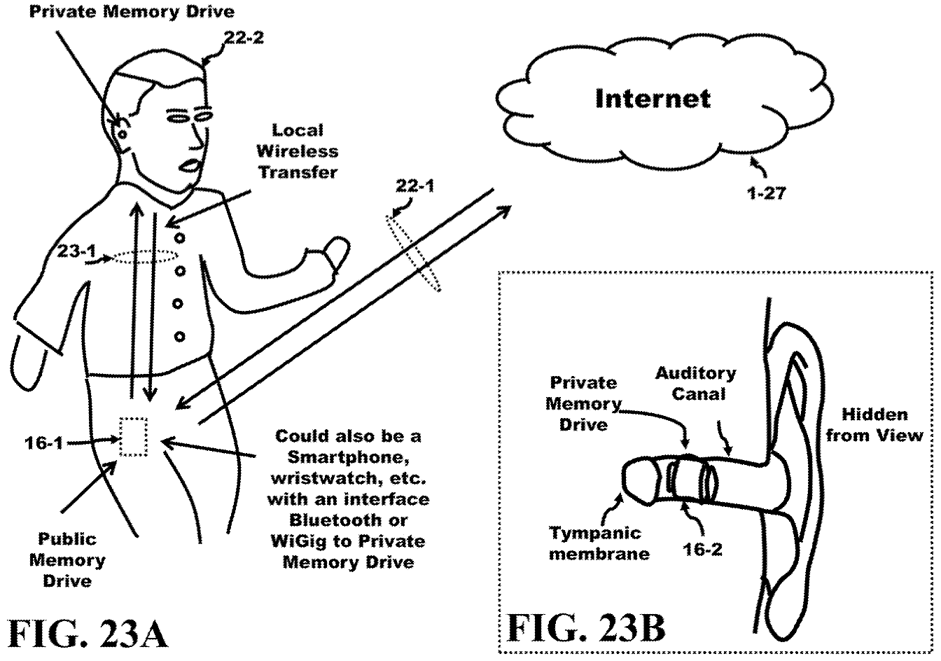

FIG. 23A presents a partitioned Personal Memory Drive where the Private Memory Drive is inserted into the air canal of user 22-2 while the Public Memory Drive 16-1 is placed within a pocket of the user. The Public Memory Drive can have an electronic complexity that can be found in the smart phone. The device can be placed on the wrist much as a wristwatch and has an wireless interface using the Bluetooth, Wi-Fi or some other IEEE standard communicating to the Private Memory Drive. Between the Public Memory Drive 16-1 and a Private Memory Drive the communication link 23-1 is illustrated. And between the Public Memory Drive and the Internet 1-27 is another communication link 22-1. FIG. 23B illustrates the Private Memory Drive 16-2 inserted inside the ear canal of the user.

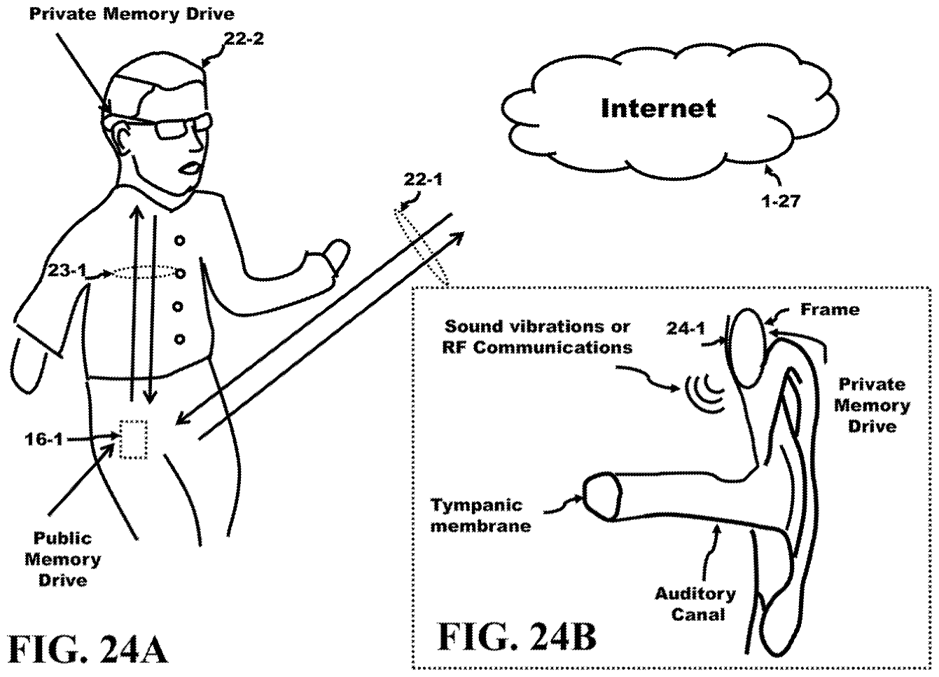

FIG. 24 a presents as similar diagram as discussed in FIG. 23 with the exception that the Private Memory Drive is embedded in a pair of eyeglasses. The Public Memory Drive 16-1 located in the pocket and communicates to the pair of eyeglasses by the communication link 23-1 and as illustrated in FIG. 24B, the frame of the eyeglasses 24-1 contains the Private Memory Drive where the transducer, in this example, creates a vibration and sends the audio through the bone and flesh of the user 22-2 to the tympanic membrane.

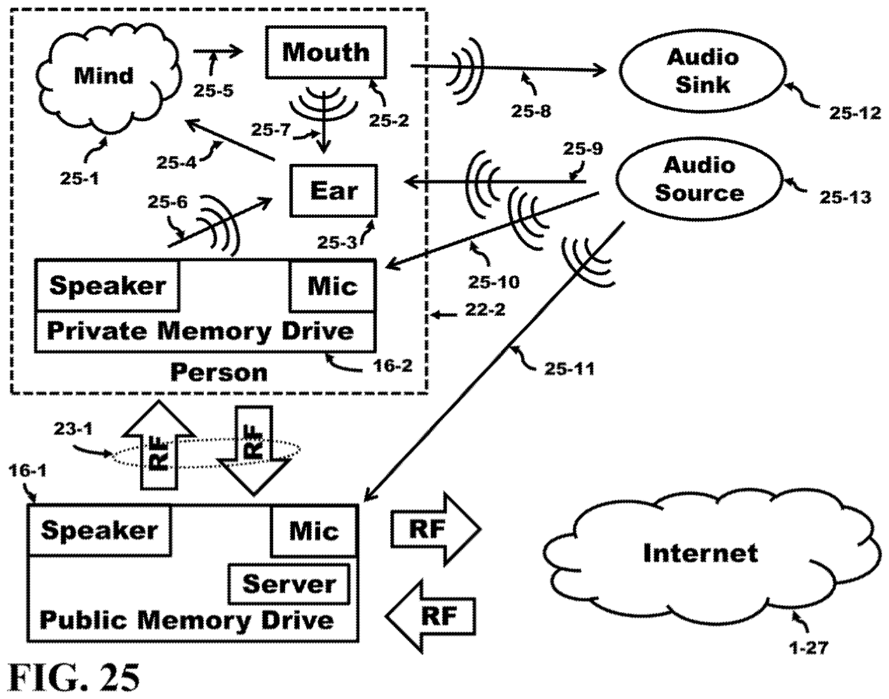

FIG. 25 presents one embodiment of a block diagram equivalent to that of FIG. 23A or FIG. 24A. The Public Memory Drive 16-1 contains transducers such as a speaker and a microphone and has an internal server that communicates with the Internet 1-27 using the RF communication. The Public Memory Drive also communicates with the Private Memory Drive 16-2 through the RF interface 23-1. The person is represented by the dotted box 22-2 which contains their mind 25-1, the mouth 25-2, and the ear 25-3. The Private Memory Drive also contains transducers of a speaker and a microphone where the speaker generates sound 25-6 that is coupled to the user's ear 25-3. When the user speaks from his mouth 25-2, the sound 25-7 goes to the ear and also to the microphone of the Private Memory Drive 16-2. The mind sends messages to the mouth via 25-5 and receives input from the ear on 25-4. Externally there's an audio sink 25-12 which is receiving the sound 25-8 made by the user and the audio sink can also have an audio source 25-13 which emits audio along 25-9 to the ear, along 25-10 to the microphone of the Private Memory Drive, and a long path 25-11 to the microphone of the Public Memory Drive. The audio of the conversation between the user 22-2 and the external audio sink and source which can represent one or more individuals and is all captured by both the Private Memory Drive in the Public Memory Drive. The information that's captured is analyzed with internal and external search engines to search for new information from the snippets which is eventually provided to the Private Memory Drive such that speaker generates the newly found information along audio path 25-6 to the ear of the user allowing the user to the process the new information and decide how to integrate this new information into what the user may want to incorporate into the conversation. The audio path 25-6 is not heard by others.

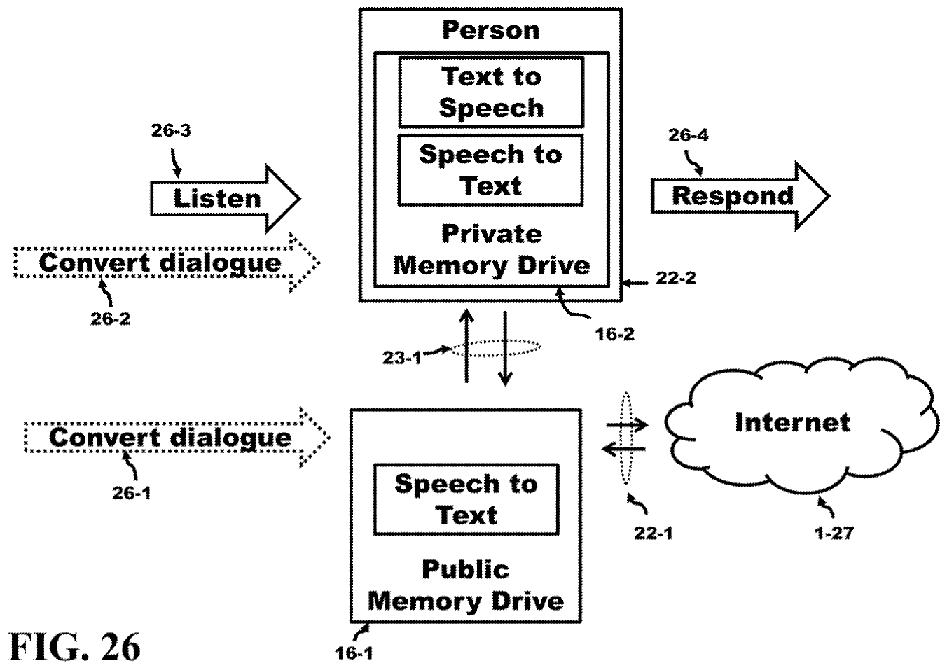

A higher level representation of FIG. 25 is illustrated in FIG. 26. The person 22-2 is listening 26-3 to the dialogue of a conversation. Simultaneously, the Private Memory Drive 16-2 is converting the dialogue 26-2 into text while the Public Memory Drive 16-1 is also converting the dialogue 26-1 into text. Internal searches are performed in the Private Memory Drive and the Public Memory Drive where in addition the text after being analyzed is sent along the communication link 21-1 to the Internet for further search analysis where the search results are returned to the Public Memory Drive. The Public Memory Drive after analyzing the information sends content along the link 23-1 to the Private Memory Drive which combines all search results and provides information to the user 22-2. The user can receive this information during periods of silence, or controlled by the user using brain waves coupled to the Private Memory Drive to provide the information to the user when the user is cognizant of the conversation that is ongoing and capable of receiving the information from the Private Memory Drive without interfering with his ability to continue the conversation. The user can also receive this information while the conversation is ongoing, in this case, the user will have to turn attention to hearing the snippets and may lose some details of the ongoing conversation. The user can listen to several snippets in this case. After analyzing the information, the user can make a decision of incorporating the newly found information with the conversation that the user one of presented and responding 26-4 to the ongoing communication.

The snippets go into the queue from the top of the queue. As the snippets are written into the queue, new snippets are placed on top, unless the previous snippet was accessed, and push the existing snippets lower in the queue. The queue stores a history of the conversation where the most recent portion of the conversation is on top of the queue. Those snippets lower in the queue contain information from an earlier portion of the conversation. The queue is a database holding snippets that were determined to be very pertinent to the conversation. Sometimes, the conversation reverts to a previous topic. The queue is one of the databases that is also searched when terms are extracted from the conversation. The snippets in the queue when extracted during a search of the queue database would have a very high rank increasing the likelihood that the snippets will be presented to the user if the conversation reverts to an earlier topic. Otherwise, depending on the content of the conversation, the snippets are popped off the top of the queue since these snippets would be more relevant to the ongoing conversation.

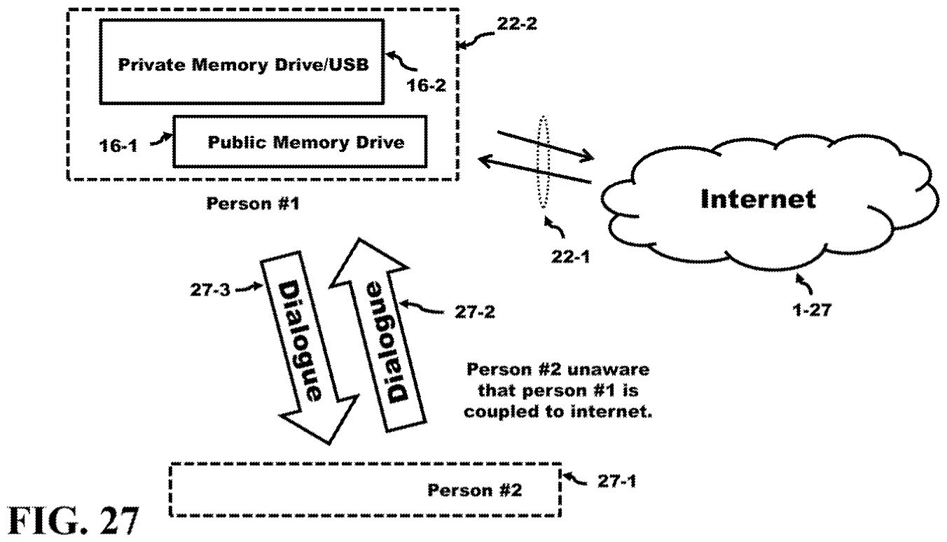

A higher level diagram of FIG. 26 is presented in FIG. 27. The user 22-2 also has access to both Public Memory Drive 16-1 and the Private Memory Drive 16-2. The Public Memory Drive interfaces with the Internet 1-26 over the link 22-1. In addition, the Public Memory Drive and the Private Memory Drive interface with a at least one person in the conversation with dialogue 27-3 to the individual or receiving dialogue 27-1 from the individual. The Public Memory Drive and Private Memory Drives can be hidden on the user 22-2 such that the at least one person in the conversation is unaware that the user 22-2 is being aided by search information from various databases.

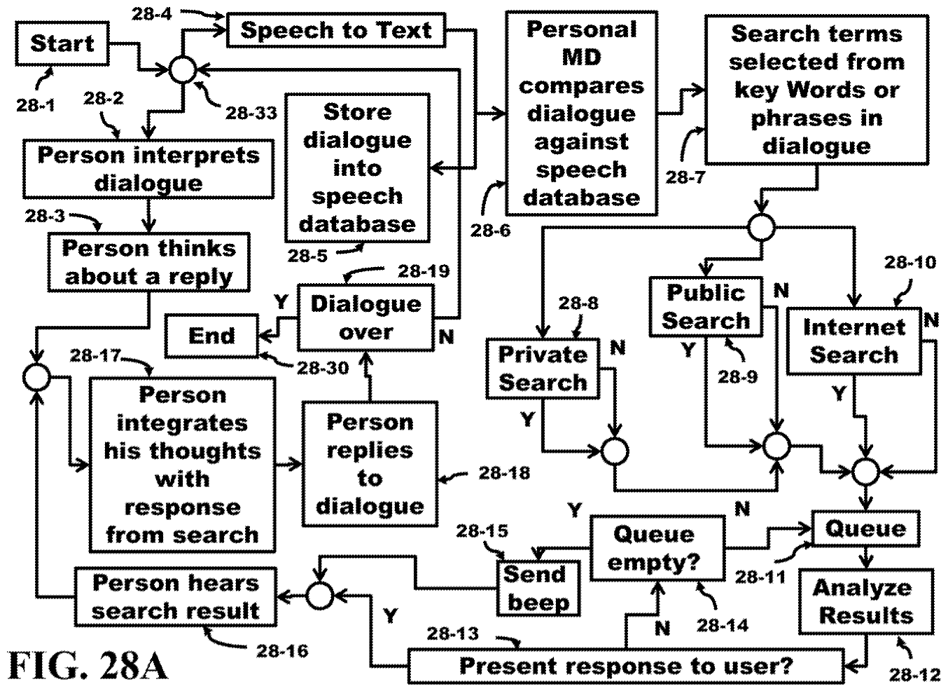

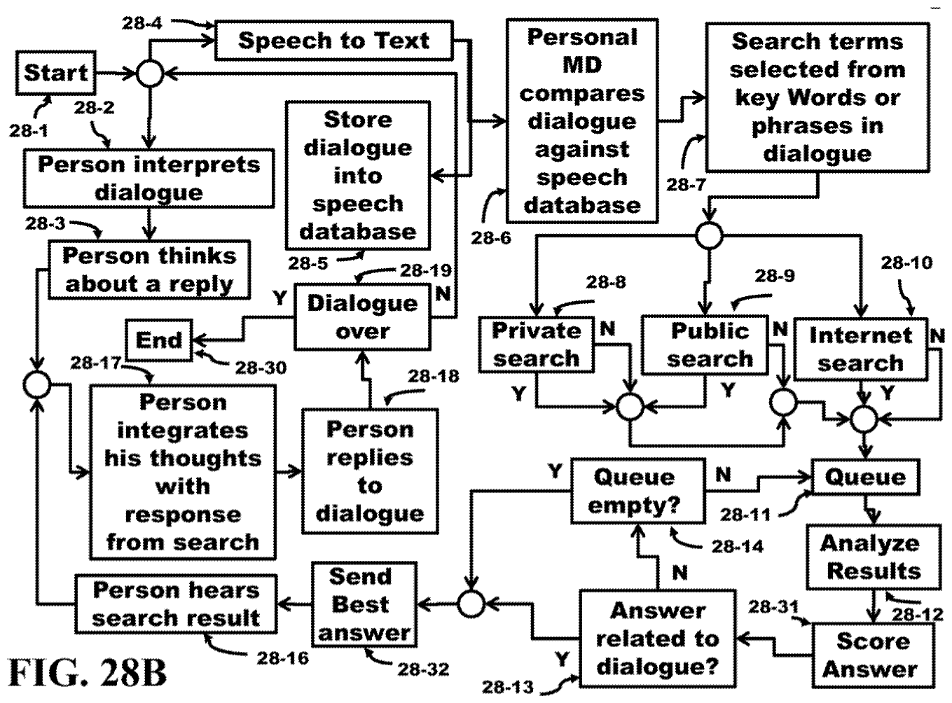

A flowchart illustrating one embodiment of how the system in FIG. 27 operates is presented in FIG. 28A. Beginning at start 21-1, the system branches into two directions. Any dialogue is converted from speech to text device 28-4 and stored in a speech database 28-5, while the Personal Memory Drive compares the dialogue against its speech database 28-6. Search terms are selected from key words and phrases in the dialogue 28-7 and these search terms can be applied to three different search engines operating on three different databases. Each of the three database searches can be selectable. A decision to perform a Private Memory Drive is made at private database search 28-8, where the private database may or may not be searched for the terms. The Public Memory Drive can have a public database search 28-9 performed, if selected. Finally, the Internet 28-10 can be searched for the terms, if desired. The search can be made using any one of the databases, any two of the databases, or all databases. For example, a Public database and Internet search for the terms can be made bypassing the Private database search, or a search of only the Private database can be made bypassing the Public database and the Internet search. Whatever combination of databases are selected to be searched, the results are collected together and placed in a queue 28-11. The queue contains the results from the selected database searches and these results can contain snippets of the search results. The queue can be a memory or a queue database configured from one or more memories. These snippets of these search results can be analyzed 28-12 to determine if the response to the dialogue is sent to the user 28-13. One of the many analysis results can return the top search result snippet (in the number 1 position) or one of the results within the top three, for example. In this case, the algorithm of the search engine is used to determine the “best” result for the given search term or terms. If a best result is selected, the results are applied to the transducer of the Private Memory Drive allowing the person or user to hear the results 28-16. If the response is not presented to the user, the queue is determined to see if it's empty 28-14. If not, analyze the next result, otherwise, send the beep or vibration to the user letting the user know that the search result so far as unsatisfactory. Once the user hears a search result, the user can integrate this snippet with his thoughts using the response from the search 28-17 and use that response to add to the dialogue 28-18. If the dialogue is not over 28-19, moved to 28-33 and repeat the process. Otherwise, if the conversation is over and 28-30 the process.

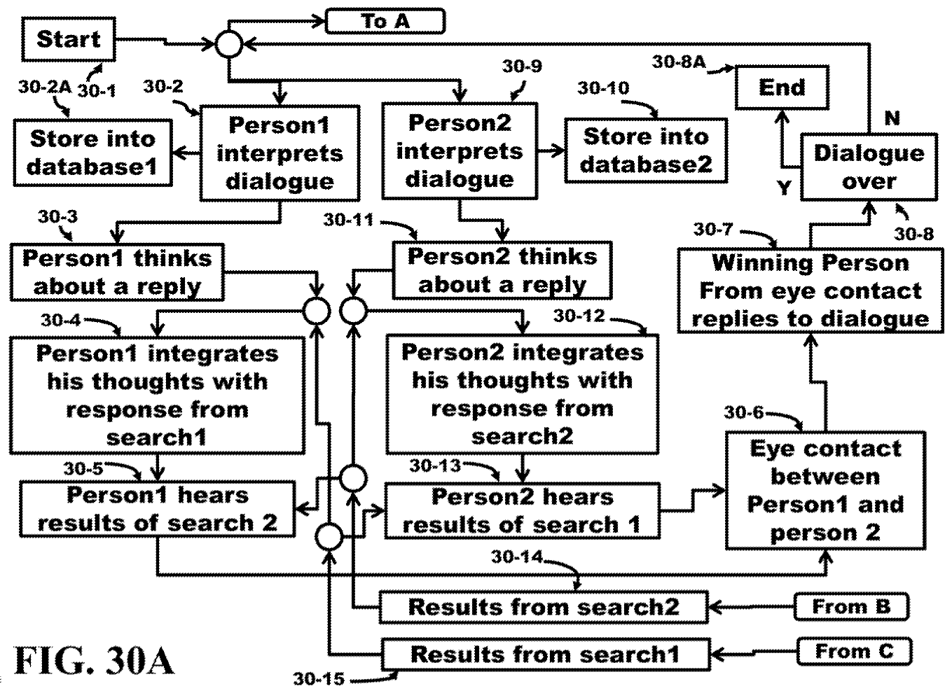

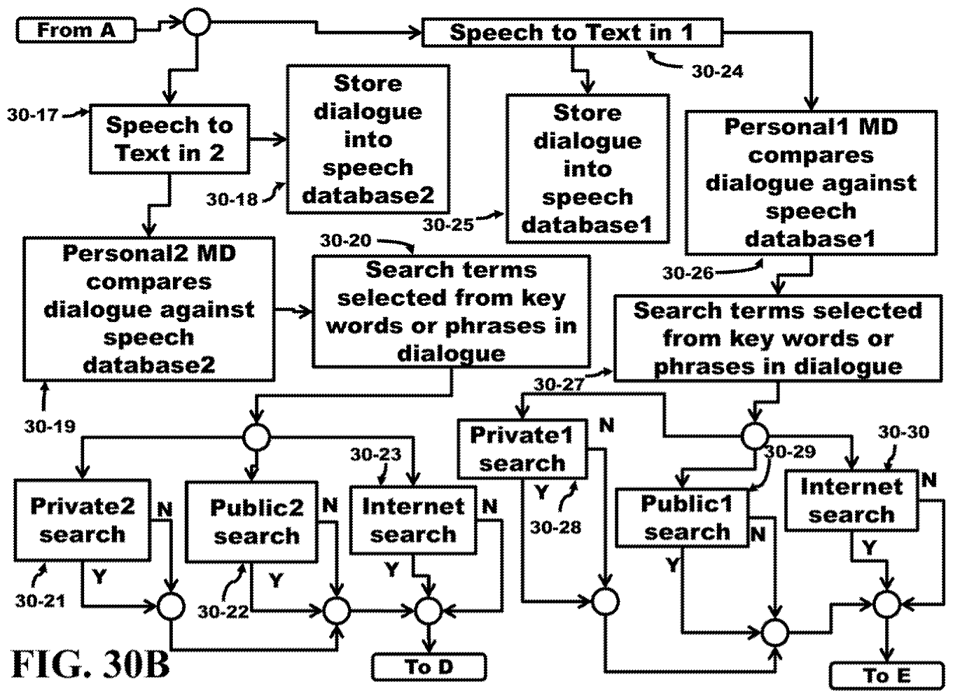

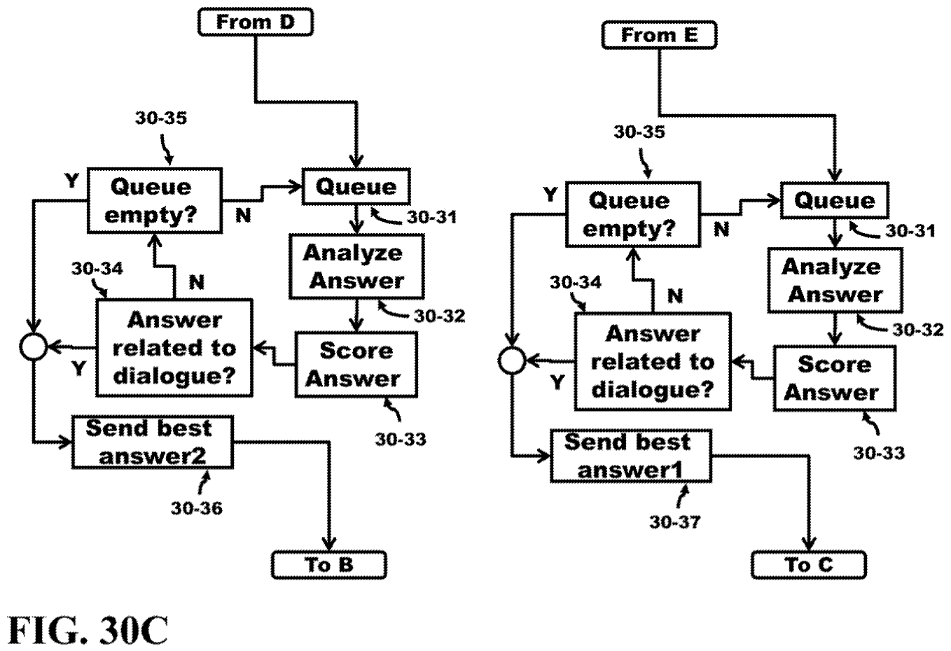

The decision to search the various databases can be set when start 28-1 begins. There may be instances when the discussion may pertain to an area that one is well versed in and the need for performing the Private database search may not be necessary since the individual is already knowledgeable in the area. Another case is where the user may have built and accumulated a significant database in their Public database and the user feels that this database would contain sufficient data, thereby eliminating the need for the Private and Internet database search. Another case is where two users want to share the knowledge of each of their Public database but none of their Private databases as will be seen when FIG. 30A-C is discussed.

FIG. 28B illustrates another embodiment of the flowchart. The process flow is very similar to the previous diagram except once when the analyzing results 28-12 is entered. At this point, the answer is scored 28-31. Then, the answer is determined to see of its related to the dialogue 28-13 by comparing terms from the ongoing speech to terms extracted from the search. If the match between these comparisons is high, the search result appears to be related to the ongoing conversation. If so, the best answer 28-32 is forwarded to the person. Otherwise the process remains the same, where if the queue is not empty, the move to the queue 28-11 and continue the analysis. Once the user hears the best answer 28-16, the process continues as described in the previous diagram.

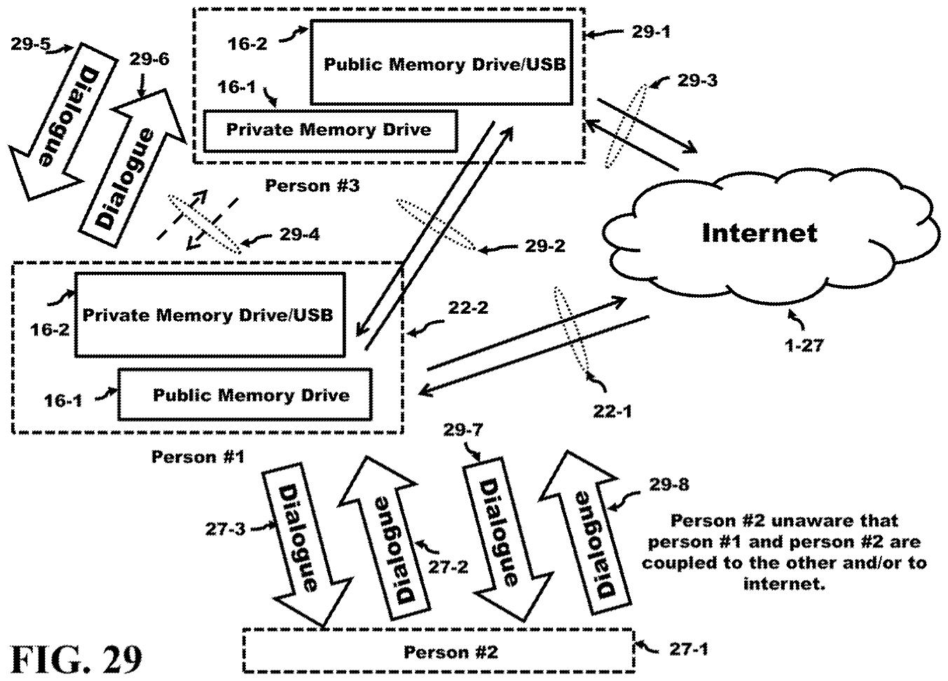

FIG. 29 depicts two individuals 22-2 and 29-1 each having a Personal Memory Drive hidden and in communication with each other unknown to person #2 27-1. Basically, the two users that are equipped with the Personal Memory Drive are receiving information from the Internet as well as their own personal databases while the dialogue of the group is occurring. This additional information can be advantageously used by the two users that are equipped with the Personal Memory Drives. FIG. 29 is very similar to FIG. 27 with the addition of the additional person #3 29-1. The additional person #3 29-1 introduces some new communication paths such as the dialogue between user 22-2 and 29-1 illustrated by the dialogue arrows 29-5 and 29-6. In addition, the Private Memory Drives may be communicating via RF along the communication path 29-4, while the Public Memory Drives can communicate via RF along the communication path 29-2. The Public Memory Drive of 29-1 communicates to the Internet via 29-3. And a new dialogue path opens between the new person #3 29-1 and the person #2 27-1 via the dialogue arrows 29-7 and 29-8. The person 42 27-1 is unaware that the other two people (#1 and #3) in the conversation are coupled to each other and or to the Internet or Internet. Such a connection, provides advantages to the two users of person #1 and #3 22-2 and 29-1 particularly if this is a business transaction. For example, stock prices and other considerations can be presented to these two users in the conversation without the knowledge of person #2 27-1 knowing.

FIG. 30A illustrates one embodiment of a flowchart describing FIG. 29. When all three meet to start a dialogue at start 30-1, the discussion is interpreted by the Personal Memory Drives held by person #one and person #two 30-2 and 30-9. Simultaneously, search results are performed by following the path “to A” which is found in FIG. 30B. The speech to text in person #one 30-24 is stored into a speech database #one 30-25. In addition the speech to text in person #two 30-17 is stored in speech database #two 30-18. The Personal Memory Drive of person #two compares the dialogue against speech database #two 30-19 and searches for terms selected from the keywords or phrases in the dialogue 30-20. Simultaneously, the Personal Memory Drive of person #one compares the dialogue against speech database #one 30-26 and search for terms selected from the keywords or phrases in the dialogue 30-27. The decision to search any of the three databases for person #two is carried out in their private database 30-21, the public database 30-22, and the Internet search 30-23. The decision to search any of the three databases for person #one is carried out in their private database 30-28, the public database 30-29, and the Internet search 30-30. The process results for each of the searches moves “to D” and “to C” respectively in FIG. 30C. The results “from D” and “from E” are applied to a queue 30-31 where an analysis is performed 30-32 and the results of the analysis determines a score 30-33. If the answer is related to the dialogue 30-34 send the best answer of #two 30-36 to “to B” and if the answer is related to the dialogue 30-34 send the best answer of #one 30-37 to “to C”. If not, and the queue is not empty 30-35 return to the queue 30-31 and repeat the process for each person #one or #two. Otherwise, select the best answer 30-36 and 30-37, and return to FIG. 30A.

In FIG. 30A, the results from search #one 30-15 are shared with person #two 30-13 and the results from search #two are shared with person #one 30-5. After person #one interprets the dialogue 30-2, the dialogue is stored into database 30-2A while person one is thinking about a reply 30-3. Simultaneously, person #two after interpreting the dialogue 30-9 is also thinking about a reply 30-11 while the dialogue is stored in database #two of person #two database 30-10. All this is going on simultaneously while results are being analyzed by the Personal Memory Drives of their own system and the system of their partner. Person #one integrates his thoughts with the response from search engine #one 30-4 while person #two integrates his thoughts with the response from search engine two 30-12. Person #one hears results of the search engine #two 30-5 and person #two hears results of search engine #one 30-13. Now person #one and person #two can use eye contact 30-6 to indicate how they should respond where the winning person from the eye contact response replies to the dialogue 13-7. If the dialogue is over 30-8, the process ends 30-8A.

Finally, it is understood that the above description are only illustrative of the principle of the current disclosure. Various alterations, improvements, and modifications will occur and are intended to be suggested hereby, and are within the spirit and scope of the disclosure. This disclosure may, however, be embodied in many different forms and should not be construed as limited to the embodiments set forth herein. Rather, these embodiments are provided so that the disclosure will be thorough and complete, and will fully convey the scope of the disclosure to those skilled in the arts. It is understood that the various embodiments of the disclosure, although different, are not mutually exclusive. The data from the memory can be translated into display data by the processor. The microprocessor could also be a DSP, microcontroller, multi-core processor, or any comparable computational unit. In accordance with these principles, those skilled in the art may devise numerous modifications without departing from the spirit and scope of the disclosure. A wireless link can be established using the protocols of IEEE 802.11, Bluetooth, 3G, 4G, or LTE. The wireless link can be established with a smart phone, tablet, computer, or wearable electronics.

What is claimed is:

1. A Personal Memory Drive for a conversation comprising:
a personal memory drive coupled to an owner;
wherein the personal memory drive is configured to transmit search terms extracted from the conversation to at least one database and is configured to receive search results from the at least one database; and
a text to speech translator configured to convert the search results to a search result speech, wherein of the search result speech, at least one snippet is configured to be heard by the owner.

2. The apparatus of claim 1, wherein
the snippet is configured to be generated during the conversation between the owner and others.

3. The apparatus of claim 1, wherein
the snippet is configured to be heard by the owner during a period of silence in the conversation or during a period of concentration of the owner that is sensed by a brain wave transducer in the personal memory drive that is in contact with an ear canal of the owner.

4. The apparatus of claim 1, wherein
the personal memory drive is inserted within an ear canal of the owner, wherein the personal memory drive can be hidden from view.

5. The apparatus of claim 1, wherein
the at least one database is selected from the group consisting of a private database available only to the owner, a public database available to other users selected by the owner and an Internet database available to anyone.

6. The apparatus of claim 1, wherein
the personal memory drive is configured to communicate with other personal memory drives owned by other users, other PCs, and the Internet.

7. The apparatus of claim 1, further comprising:
at least one local search engine configured to search at least one local memory, wherein the at least one local memory is configured to have at least one local database; and
at least one local server serving the at least one local database.

8. The apparatus of claim 1, wherein
a dialogue of the conversation is heard by the owner;
a reply to the dialogue is thought out by the owner after integrating both the dialogue and the at least one snippet from the total search speech, wherein
the reply is added to the conversation by the owner.

9. A Personal Memory Drive (PMD) comprising:
a private memory drive coupled to an owner; and
a public memory drive wirelessly coupled to the private memory drive,
wherein the public memory drive is configured to transmit search terms to the Internet extracted from a conversation and is configured to receive global search results from the Internet,
wherein the public memory drive is configured to transmit the search terms to a public database and is configured to receive public search results from the public database,
wherein the private memory drive is configured to transmit the search terms to a private database and is configured to receive private search results from the private database,
wherein the public and global search results received by the public memory drive are transmitted to the private memory drive,
wherein all search results are combined into a total search result; and
a text to speech translator configured to convert the total search result to a total search speech, wherein of the total search speech, at least one snippet is configured to be heard by the owner.

10. The apparatus of claim 9, wherein
the snippet is configured to be generated during the conversation between the owner and others.

11. The apparatus of claim 9, wherein
the snippet is configured to be heard by the owner during a period of silence in the conversation or during a period of concentration of the owner that is sensed by a brain wave transducer that is in contact with an ear canal of the owner in the personal memory drive.

12. The apparatus of claim 9, wherein
the private memory drive is inserted within an ear canal of the owner, wherein the private memory drive can be hidden from view.

13. The apparatus of claim 9, wherein
the conversation is occurring between the owner and at least one other person selected from the group consisting of a person sharing a room with the owner, a person sharing a telephone call with the owner and a person not aware the owner is being aided by the PMD.

14. The apparatus of claim 9, wherein
the personal memory drive is configured to communicate with other personal memory drives owned by other users, other PCs, and the Internet.

15. The apparatus of claim 9, further comprising:
at least one local search engine configured to search at least one local memory, wherein
the at least one local memory is configured to have at least one local database; and
at least one local server serving the at least one local database.

16. The apparatus of claim 9, wherein
a dialogue of the conversation is heard by the owner,
a reply to the dialogue is thought out by the owner after integrating both the dialogue and the at least one snippet from the total search speech, wherein
the reply is added to the conversation by the owner.

17. A method of an owner of a Personal Memory Drive (PMD) and the PMD both responding to a conversation comprising the steps of:
listening to a dialogue of a conversation performed by the owner;
thinking about a reply to the dialogue performed by the owner;
configuring a speech to text device of the PMD to translate the dialogue into text;
selecting search terms from the text of the dialogue performed by the PMD;
searching in at least one database for the search terms performed by the PMD;
queuing a result of the searching into a queue database performed by the PMD;
selecting at least one snippet from the queue database performed by the PMD;
configuring a text to speech device of the PMD to translate the at least one snippet into a search result dialogue;
providing the search result dialogue to the owner;
integrating at least one thought between that of thinking about the reply to the dialogue and the search result dialogue provided to the owner by the PMD; and
replying to the dialogue of the conversation using a result of integrating the at least one thought.

18. The method of claim 17, wherein
the conversation is occurring between the owner and at least one other person selected from the group consisting of a person sharing a room with the owner, a person sharing a telephone call with the owner and a person not aware the owner is being aided by the PMD.

19. The method of claim 17, wherein
the at least one database is selected from the group consisting of a private database available only to the owner, a public database available to other users selected by the owner and a database of the Internet available to anyone

20. The method of claim 17, wherein
the at least one snippet is configured to be heard by the owner during a period of silence in a conversation or during a period of concentration of the owner that is sensed by a brain wave transducer that is in contact with an ear canal of the owner in the PMD.
